(19) United States
(12) Patent Application Publication
(10) Pub. No.: US 2009/0074966 A1
(43) Pub. Date: Mar. 19, 2009

(54) SYSTEM AND METHOD FOR CREATING A SURFACE PATTERN

(76) Inventors: Eric R. Henderson, Ames, IA (US); Curtis L. Mosher, Ames, IA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/813,592

(22) PCT Filed: Jan. 10, 2006
(86) PCT No.: PCT/US06/00708

§ 371 Date: Sep. 15, 2008

Related U.S. Application Data
(60) Provisional application No. 60/643,084, filed on Jan. 10, 2005.

(51) Int. Cl. B05D 5/00

(52) U.S. Cl. 427/256; 118/695

(57) ABSTRACT

Some embodiments of the disclosed surface patterning systems and methods utilize a surface patterning tool coupled to a support and adapted to deposit material onto a substrate, a controller, and first, second, and third actuators electrically coupled to and controlled by the controller. In some embodiments, the first, second, and third actuators are operable to move the substrate in X, Y, and Z directions, respectively, with respect to the surface patterning tool, wherein the substrate is movable by the first, second, and third actuators to different positions with respect to the surface patterning tool, and wherein material is transferable from the surface patterning tool to the substrate in each of the different positions to define the desired surface pattern. One or more of the actuators in some of the disclosed embodiments are piezoelectric actuators.

### RELATED APPLICATIONS

Priority is hereby claimed to U.S. Provisional Patent Application No. 60/643,084, filed Jan. 10, 2005, the entire contents of which are incorporated herein by reference. In addition, this is a continuation-in-part patent application of U.S. patent application Ser. No. 09/929,865, filed Aug. 14, 2001, the entire contents of which are incorporated herein by reference, and claims priority to U.S. Provisional Patent Application No. 60/225,434, filed Aug. 15, 2000.

### BACKGROUND

Measuring the binding affinity between materials, molecules, and cells is key to a broad spectrum of industries, including material development, semiconductor production, bioanalytical assays, biomedical diagnostics, and drug discovery. With the emergence of solid state array-based bioanalytical and genetic diagnostic instruments and related equipment, new methods for cost effective screening of a large number of reactions in a miniaturized solid state form have become increasingly desirable. A favored approach to date is to monitor changes in optical properties, usually fluorescence, when a known, fluorescently labeled molecule interacts with a known molecular species at a specific address in a molecular array. Such methods, however, often impose stereochemical constraints by the addition of reporter systems to the molecules used to interrogate the molecular array. Thus, label free, direct interrogation of molecular binding events using a micromechanical reporter is of obvious utility. More sophisticated and robust instrumentation for the creation of these molecular arrays is therefore desirable.

One method for the direct detection of molecular interaction events is the scanning probe microscope. One type of scanning probe microscope is the atomic force microscope (“AFM”). In the AFM, a sharp tip is situated at the end of a flexible cantilever and scanned over a sample surface. While scanning, the cantilever is deflected by the net sum of the attractive and repulsive forces between the tip and sample. If the spring constant of the cantilever is known, the net interaction force can be accurately determined from the deflection of the cantilever. The deflection of the cantilever is usually measured by the reflection of a focused laser beam from the back of the cantilever onto a split photodiode, constituting an “optical lever” or “beam deflection” mechanism. Other methods for the detection of cantilever deflection include interferometry and piezoelectric strain gauges.

The first AFMs recorded only the vertical displacements of the cantilever. More recent methods involve resonating the tip and allowing only transient contact, or in some cases no contact at all, between it and the sample. Plots of tip displacement or resonance changes as the tip traverses a sample surface are used to generate topographic images. Such images have revealed the three dimensional structure of a wide variety of sample types including material, chemical, and biological specimens. Some examples of the latter include DNA, proteins, chromatin, chromosomes, ion channels, and even living cells.

In addition to its imaging capabilities, the AFM can make extremely fine force measurements. The AFM can directly sense and measure forces in the micronewton (10-6) to picoNewton (10-12) range. Thus, the AFM can measure forces between molecular pairs, and even within single molecules. Moreover, the AFM can measure a wide variety of other forces and phenomena, such as magnetic fields, thermal gradients and viscoelasticity. This ability can be exploited to map force fields on a sample surface, and reveal with high resolution the location and magnitude of these fields, as in, for example, localizing complexes of interest located on a specific surface. To make molecular force measurements, the AFM probe may be functionalized with a molecule of interest.

Construction of molecular arrays on a solid support for use in an AFM is typically carried out by processes that can be divided into two general classes: in situ and ex situ, the latter including a mechanical deposition step to actually place the sample on the deposition surface. In situ synthesis methods and apparatuses may involve photochemical synthesis of nucleic acid or short peptides to define the spatial addresses on a silicon or a glass surface. These methods may be limited by the wavelength of light used for masking and the synthetic procedure. Furthermore, this procedure may also be limited by cost. A need therefore exists for a dedicated apparatus for the creation of molecular arrays that may create arrays in a quick and efficient manner.

An example of an ex situ method followed by the mechanical deposition on the surface may be illustrated by the “dip pen” method. The sample material is prepared in advance and then the dip pen is used to place the sample on the deposition surface. It has been shown that a dip-pen method may be used to draw a submicron molecular line or spot using an alkanethiolate monolayer utilizing a standard AFM to control the dip pen. Other prior art instruments may utilize a pin tool which is dipped in a solution containing the sample material. The pin tool then has a drop of solution on it, which is then placed on the deposition surface. This method, however, does not allow the creation of extremely small deposition domains. Up until this time, AFMs have been utilized for drawing sub-micron molecular lines or creating the molecular spots. AFMs, however, are not optimal for creating arrays because they lack features, such as a sub-micron precision sample stage under computer control, precise optical access for sample registration, and unencumbered access to the software code used to control tip motion. Furthermore, commercial AFM configurations are not amenable to the rapid deposition of large numbers of different molecular species. Finally, AFMs are designed for multiple tasks, not as a dedicated sample deposition instrument, and are therefore more expensive than is required for a dedicated arrayer. Still other features may also be desirable in a dedicated deposition instrument and not included with an AFM.

A need exists for a commercially practical deposition instrument that can be utilized to create a molecular deposition array or surface pattern that includes sub-micron deposition domains. This instrument may incorporate precise optical features for sample registration and may be controlled utilizing a computer control so that user defined array patterns and sizes may be created. It may be particularly advantageous if this instrument can operate autonomously in a high throughput format.

### SUMMARY

Some embodiments of the present invention provide an apparatus for creating molecular arrays comprising a base, a Z controller operably connected to the base wherein the Z controller is selectively positionable along a Z axis, a deposition probe removably and operably connected to the Z controller so that the deposition probe is selectively positionable along the Z axis by the Z controller, an X, Y controller operably connected to the base wherein the X, Y controller is selectively positionable along an X axis and a Y axis, the X, Y controller further comprising a deposition substrate operably attached thereto and wherein movement of the X, Y controller moves the deposition substrate between a first position and a second position, the second position being operably positioned relative to the deposition probe, and an X, Y translation stage operably connected to the base wherein the X, Y translation stage is selectively positionable along an X axis and a Y axis, the X, Y translation stage further comprising a loading substrate operably attached thereto and wherein movement of the X, Y translation stage moves the loading substrate between a first position and a second position, the second position being operably located relative to the deposition probe and the first position being in a position accessible by the user.

In some embodiments of the present invention, a method for creating a deposition domain is provided, and comprises: (a) obtaining a loading substrate, the loading substrate further including a deposition material, (b) loading the deposition material onto a deposition probe, and (c) creating a deposition domain on a deposition substrate by transferring a desired amount of the deposition material from the deposition probe to the deposition substrate.

Some embodiments of the present invention provide an apparatus for creating an array comprising: a Z controller, a deposition probe operably attached to the Z controller, the deposition probe further comprising a tip, an X, Y controller operably attached to the Z controller, the X, Y controller selectively movable between a first position and a second position, and a deposition substrate operably affixed to the X, Y controller, wherein when the X, Y controller moves the deposition substrate to the second position the deposition substrate is operably positioned relative to the deposition probe.

In some embodiments, the present invention is a dedicated instrument for the creation of molecular arrays comprising deposition domains as small or smaller than 1 micron. Utilizing the present invention, an arrayer may limit the use of expensive reagents and test materials and may further help to conserve space in large scale combinatorial chemistry labs. Finally, some embodiments of the present invention may permit the testing of a large number of samples in a high throughput format because of the ease of making custom designed arrays with a variety of deposition materials placed thereon.

In some embodiments, the present invention utilizes a deposition technique in which a sample is transiently hydrated to form a capillary bridge. The capillary bridge may transport the deposition material from a loading substrate, to a deposition probe, and from the deposition probe to a deposition substrate to create a deposition domain. One or more deposition domains make up the array. The capillary bridge deposition technique utilized by the present invention apparatus is further described herein, and is also described in detail in co-pending U.S. application Ser. No. 09/574,519, which is herein incorporated by reference for all that it teaches.

Some embodiments of the present invention provide a system for depositing a material onto a substrate to create a desired surface pattern, wherein the system comprises a support; a surface patterning tool coupled to the support, the surface patterning tool adapted to deposit the material onto the substrate; a controller; and first, second, and third actuators electrically coupled to and controlled by the controller, wherein the first, second, and third actuators are operable to move the substrate in X, Y, and Z directions, respectively, with respect to the surface patterning tool, wherein the substrate is movable by the first, second, and third actuators to different positions with respect to the surface patterning tool, and wherein material is transferable from the surface patterning tool to the substrate in each of the different positions to define the desired surface pattern.

In some embodiments, a system for depositing a material onto a substrate to create a desired surface pattern is provided, and comprises a support; a surface patterning tool coupled to the support, the surface patterning tool adapted to deposit the material onto the substrate; a controller; and first and second piezoelectric drives electrically coupled to and controlled by the controller, wherein the first and second piezoelectric actuators are operable to move the substrate in X and Y directions, respectively, with respect to the surface patterning tool, wherein the substrate is movable by the first and second piezoelectric actuators to different positions with respect to the surface patterning tool, and wherein material is transferable from the surface patterning tool to the substrate in each of the different positions to define the desired surface pattern.

In some embodiments, a method of depositing a material onto a substrate to create a desired surface pattern is provided, and comprises loading the material onto a surface patterning tool; actuating a first actuator to move the substrate in an X direction with respect to the surface patterning tool; actuating a second actuator to move the substrate in a Y direction with respect to the surface patterning tool; actuating a third actuator to move the substrate in a Z direction with respect to the surface patterning tool and to a position with respect to the surface patterning tool; and transferring the material from the surface patterning tool to the substrate.

Other features and aspects of the invention will become apparent by consideration of the detailed description and accompanying drawings.

### BRIEF DESCRIPTION OF THE DRAWINGS

FIG. 1 is a block diagram representing various components of one embodiment of the present invention.

FIG. 2 is a front view of the instrument of one embodiment of the present invention.

FIG. 3a is a perspective view of an X, Y controller of one embodiment of the present invention.

FIG. 3b is a perspective view of an X, Y translation stage of one embodiment of the present invention.

FIG. 4 is a perspective view of a deposition probe of one embodiment of the present invention.

FIG. 5 is a block diagram showing components of a humidity controller according to an embodiment of the present invention.

FIG. 6 is a perspective view of an arrayer according to another embodiment of the present invention.

FIG. 7 is a support for the arrayer of FIG. 6.

FIG. 8 is a partially exploded view of the arrayer of FIG. 6.

FIG. 9A is an exploded view of a printhead according to an embodiment of the present invention.

FIGS. 9B-9G are various views of an environment control system according to one embodiment of the present invention.

FIG. 10 is an exploded view of a printhead according to another embodiment of the present invention.

FIG. 11 is an alternate exploded view of the printhead of FIG. 10

FIG. 12A is an assembled view of a printhead according to another embodiment of the present invention.

FIG. 12B is a perspective of a surface patterning tool according to one embodiment of the present invention.

FIG. 13 is an exploded view of a Z printhead positioning assembly according to an embodiment of the present invention.

FIG. 14 is a perspective view of an X-Y-Z stage-positioning assembly according to an embodiment of the present invention, including an X-Y stage-positioning assembly and a Z stage-positioning assembly.

FIG. 15 is a perspective view of the X-Y stage-positioning assembly of FIG. 14.

FIG. 16 is a top view of the X-Y stage-positioning assembly of FIG. 14.

FIG. 17 is a side view of the X-Y stage-positioning assembly of FIG. 14.

FIG. 18 is another side view of the X-Y stage-positioning assembly of FIG. 14.

FIGS. 19A-19C are schematic views of a mechanism for motion control of the X-Y stage-positioning assembly of FIGS. 14-18 according to an embodiment of the present invention.

FIG. 20 is a perspective view of the Z stage-positioning assembly of FIG. 14.

FIG. 21 is a schematic view of a mechanism for motion control of the Z stage-positioning assembly of FIGS. 14 and 20 according to an embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

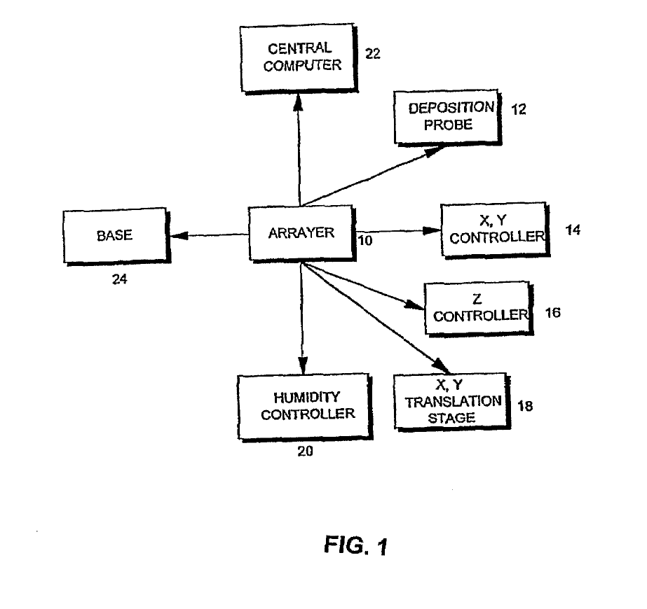

An arrayer and method of arrayer operation according to an embodiment of the present invention is illustrated in FIGS. 1-5, wherein arrays comprised of deposition domains can be created in a high throughput format. In some embodiments, the arrayer can be automatically controlled, bypassing the need for a user to constantly monitor the formation of an array. A general description of the components of the arrayer 10 will now be undertaken, followed by a more specific description of each component.

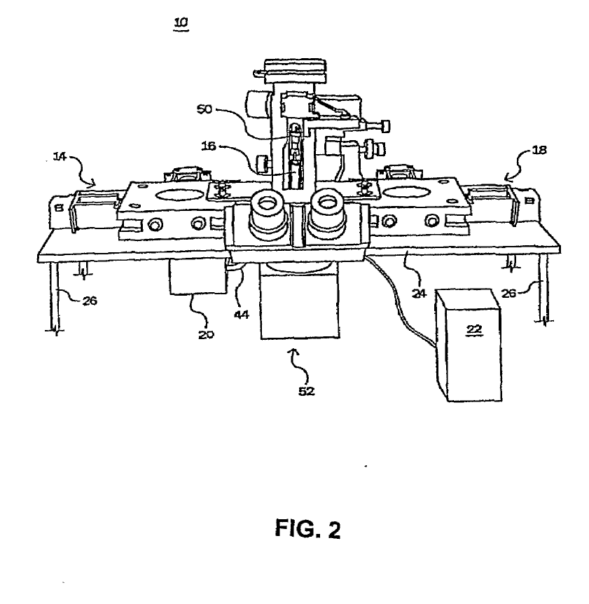

As illustrated in FIGS. 1 and 2, an arrayer 10 according to an embodiment of the present invention may be comprised of a deposition probe 12, an X, Y, controller 14, a Z controller 16, an X, Y translation stage 18, a humidity controller 20, a control computer 22, and a base 24. The deposition probe 12 may be operably connected to the Z controller 16, which in turn may be affixed to the base 24. The X, Y controller 14 may also be affixed to the base 24 on a first side of the Z controller 16. The X, Y translation stage 18 may further be affixed to the base 24 on a second side of the Z controller 16. The humidity controller 20 and the control computer 22 may be operably positioned relative to the deposition probe 12, the X, Y controller 14, and the X, Y translation stage 18 so that the humidity controller 20 may properly perform its respective function, i.e., controlling humidity. The computer 22 controls the function of the various components of the arrayer 10. As may be appreciated, a number of formations and designs imagined by those skilled in the art may be utilized to attach the X, Y controller 14, the Z controller 16, the X, Y translation stage 18, etc. to the base 24. Different orientations of the components does not alter the scope of the present invention. Furthermore, these components may be attached in a number of different ways, including bolting, welding, snapping, etc.

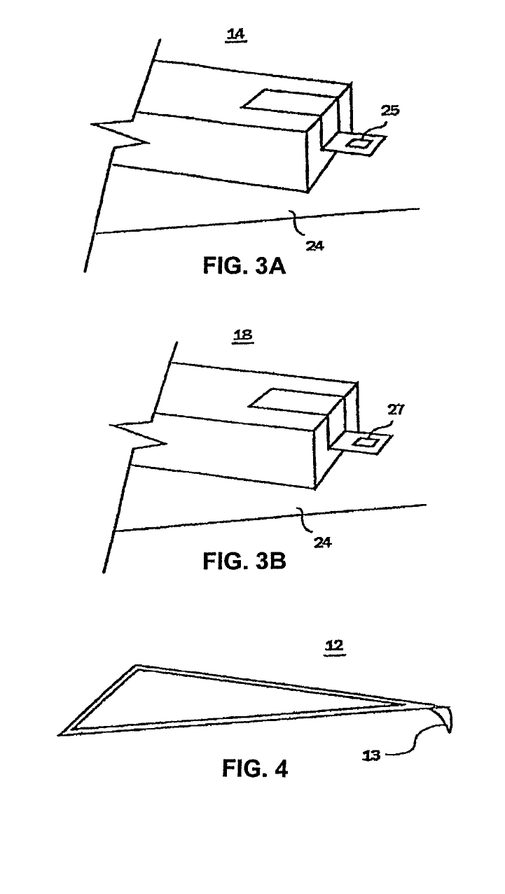

As illustrated in FIG. 3a, the X, Y controller 14 further includes a deposition substrate 25 movably and removably affixed thereto. The deposition substrate 25 is the surface upon which the present invention deposits material. The deposition substrate 25 is moved by the X, Y controller 14 into a position underneath the Z controller 16 so that the deposition probe 12 can be lowered and the deposition material deposited. The deposition substrate 25 may be affixed to the X, Y controller 14 utilizing snaps, clips, raised contours, or by other methods known to those skilled in the art. The details of how the arrayer 10 deposits the material is better understood after an explanation of each of the portions of the present embodiment. In still further embodiments, one controller may control movement of the deposition probe 12 in the X, Y, and Z directions.

The deposition substrate 25 utilized in the present invention apparatus may be formed of a variety of materials depending on the nature of the deposited material. A further description of such deposition substrates 25 can be found in U.S. application Ser. No. 09/574,519, but may be altered or changed without changing the nature or scope of the present invention.

As is further illustrated in FIG. 3b, the X, Y translation stage 18 may further include a loading substrate 27. The loading substrate 27 may be the surface on which deposition material resides before it is loaded onto the deposition probe 12, and then onto the deposition substrate 25 of the arrayer 10. The deposition material may be placed on the loading substrate 27 by methods known to those reasonably skilled in the art, such as by mechanical deposition, in situ photochemical synthesis, “ink jet” printing, and electronically driven deposition, without changing the nature and scope of the present invention.

In one embodiment, as illustrated in FIG. 2, the arrayer 10 may further comprise a force feedback monitor 50 and an optical microscope 52. The force feedback monitor 50 may be operably connected to the deposition probe 12, the Z controller 16, and the control computer 22. The force feedback monitor 50 may assist in controlling the height of the deposition probe 12 relative to the deposition substrate 25 and the loading substrate 27. The optical microscope 52 may be operably attached at a position below the base 24 suitable for observing action of the arrayer 10.

Each of these separate components of the arrayer 10 illustrated in FIGS. 1-4 will now be further described herein.

### Base 24

With reference to FIG. 2, the base 24 according to an embodiment of the present invention will be herein described. The base 24 in the illustrated embodiment of FIGS. 1-5 is physically stable and provides various places where the separate portions of the arrayer may be mounted. The base 24 of the present embodiment may utilize a 12×24 inch optical plate supported on steel posts 26. The optical plate is a standard platform for building various types of instrumentation.

One commercially available optical plate 24 that is suited for use in the arrayer 10 is available from Newport Corp., P.O. Box 19607, Irvine Calif. 92623-9607 as product number SA12. The plate may have ¼ inch holes drilled on one inch centers. Steel posts 26 well suited for the arrayer 10 are also be commercially available from the same manufacturer as product number SP12.

In alternative embodiments, the optical plate may be placed on top of an optical table. The optical table can be floated on nitrogen pistons to optimize elimination of vibrations, if desired.

### Controller 14

With reference to FIGS. 2 and 3a, the X, Y controller 14 according to an embodiment of the present invention will now be described. As illustrated in FIGS. 2 and 3a, the X, Y controller 14 may be operably attached to the base 24. In some embodiments, the X, Y controller 14 is capable of microfine and repeatable movement so that the attached deposition substrate 25 can be precisely positioned in a repeatable manner underneath the deposition probe 12. The operative end of the X, Y controller 14, as illustrated in FIG. 2, may be positioned in such a manner that the X,Y controller 14 will move the deposition substrate 25 underneath the deposition probe 12 with micron precision and will also be able to move the deposition substrate 25 out of the way to allow the X, Y translation stage 18 to move the loading substrate 27 under the deposition probe 12.

One X, Y controller 14 may be a piezo driven inchworm precision mechanical stage. The inchworm mechanism may have a significant range of motion while maintaining microfine precision desirable for some embodiments of the present invention. Such a stage may have approximately 20 nm spatial resolution in the X and Y planes and may further utilize encoders to ensure repeatability. The stage may be fitted with a plate designed by those skilled in the art to hold the sample deposition substrate 25. One inch worm stage that may be useful is commercially available from Burleigh Instruments, Burleigh Park, P.O. Box E, Fishers, N.Y. 14453-0755.

In some alternative embodiments, a piezo driven flexure stage may also be utilized as the X, Y controller 14. A piezo driven flexure may have essentially the same precision as the inchworm stage. In still further embodiments, a linear piezo ratchet mechanism, such as is available from NanoMotion, Israel, may be utilized. FIG. 2 illustrates an X, Y controller 14 with a separate motor for the X and Y directions, although various other designs may be utilized.

### X, Y Translation Stage 18

With reference to FIGS. 2 and 3b, the translation stage 18 according to an embodiment of the present invention will now be further described. The X, Y translation stage 18 can be operably attached to the base 24 in a position relative to the Z controller 16 and the deposition probe 12 such that it operably interacts with the same. In the present embodiment, the operative end of the X, Y translation stage 18 is fitted with a loading substrate 27 pre-constructed with one or more deposition materials placed thereon. The loading substrate 27 may be operably affixed to the X, Y translation stage 18 in much the same manner as the deposition substrate 25 is attached to the X, Y controller 14. As illustrated in FIGS. 2 and 3b, the X, Y translation stage may be positioned such that the loading substrate 27 can be moved into an operable position underneath the deposition probe 12.

In one embodiment, the X, Y translation stage 18 may utilize the same type of X, Y positionable inchworm or piezo device as the X, Y controller 14. In alternative embodiments, the X, Y translation stage 18 may not require such microfine control, since the deposition material may be placed in a much larger, and therefore easily accessible, domain on the loading substrate than the domain created on the deposition substrate 25. As illustrated in FIG. 2, the X, Y translation stage 18 in the illustrated embodiment of FIGS. 1-5 may have much the same design as the X, Y controller 14.

In further embodiments, the X, Y translation stage 18 may have such a range of motion that the loading substrate 27 can be loaded in a first position and then transported into a second position underneath the deposition probe 12. In this manner, the loading substrate 27 may be cleaned and reloaded with a second deposition material after the first deposition material is loaded onto the deposition probe 12, all in an automatic fashion.

### Z Controller 16

With reference to FIG. 2, the Z controller 16 according to an embodiment of the present invention will be herein further described. The Z controller 16 may be operably attached to the base 24 where it can operably interact with the X, Y controller 14 and the X, Y translation stage 18. The Z controller 16 may freely move in the vertical (Z) direction. The Z controller 16 of the present invention preferably has an accuracy of 200 nm or less in the Z direction so that the arrayer 10 may be able to accomplish repeatable and consistent deposition domains in a high throughput format. It may also be preferable for the Z controller 16 to have lateral repeatability of one micron or less so that the present invention can create high density arrays with as little as 1 to 2 microns, or less, of space between each spot on the array, i.e., the pitch.

In some embodiments, the Z controller 16 can be a commercially available controller from Newport Corporation, P.O. Box 19607, Irvine, Calif. 929623-9607, product number TSV 150. In the embodiment illustrated in FIGS. 1-5, the Z controller 16 stays relatively stationary in the X, Y directions, allowing the X, Y controller 14 and the X, Y translation stage 18 to move the substrates 25, 27 into position. In alternative embodiments, the Z controller 16 may have X, Y mobility without changing the nature and scope of the present invention.

### Deposition Probe 12

The deposition probe 12 can be fixed to the end of the Z controller 16, and is not visible in FIG. 2. With reference to FIGS. 2 and 4, the Z controller 16 according to an embodiment of the present invention will now be described in greater detail. The deposition probe 12 can preferably be 100 to 200 microns long and can have a tip 13 of roughly 1-20 microns in height. The tip 13 can have a radius of curvature of approximately 10-50 nm. In some embodiments, the deposition probe 12 is modified with a 5-10 micron diameter sphere mounted on the end of the cantilever. The manner in which the sphere can facilitate loading of the deposition probe 12 and deposition of the deposition material is further described in the above referenced patent application. Furthermore, the operative attachment of such a probe 12 to a Z controller 16 is well known to those in the art, and need not be described herein.

A commercially available deposition probe 12 may be utilized as the deposition probe 12 of the arrayer 10. Such a deposition probe 12 may be a standard silicon nitride AFM probe available from Digital Instruments/Veeco, 112 Robin Hill Road, Santa Barbara, Calif.

### Humidity Controller 20

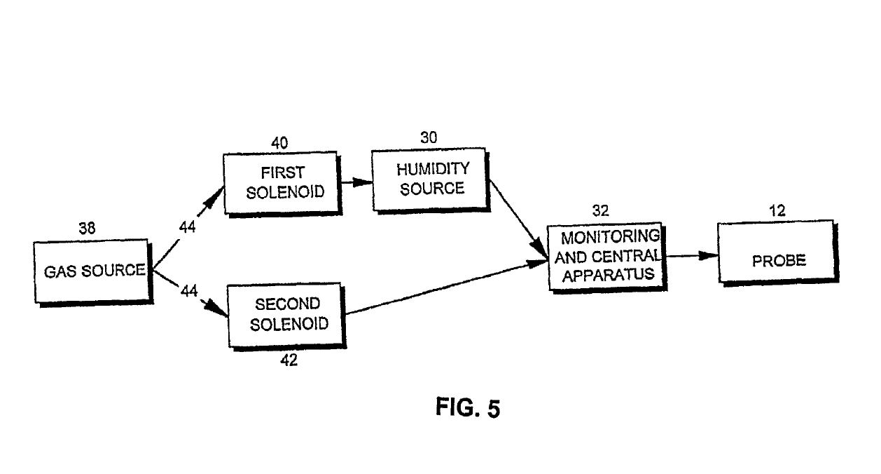

A humidity controller 20 according to an embodiment of the present invention is illustrated in FIGS. 2 and 5. As illustrated in FIG. 2, the humidity controller 20 may be operably affixed to the base 24. As illustrated in FIG. 5, the humidity controller 20 may further comprise a humidity source 30, a gas flow monitoring and control apparatus 32 (not shown in FIGS. 1-4) a gas source 38, a first solenoid valve 40, a second solenoid valve 42, and interconnective tubing 44. The humidity source 30 may be operably positioned to effectively and accurately control the humidity around the deposition probe 12 during loading and deposition of deposition material. The monitoring system 32 may be positioned between the humidity source 30 and the deposition probe 12 and controlled by the computer 22. The gas source 38 may be operably connected to the first solenoid 40 and the humidity source 30 by the tubing 44. The gas source 38 may be further connected to the second solenoid 42 by tubing 44 bypassing the humidity source 30. Furthermore, as shown in FIG. 2, tubing 44 may channel gas to the probe 12. The humidity controller 20 of the present invention may allow for the reproducible deposition of samples in sub-micron and nanometer domains.

In some embodiments, the humidity source 30 utilizes a wetted piece of filter paper or a sponge in a plastic cartridge. A dry inert gas, such as argon, is placed into the cartridge from the gas source 38 and kept under a positive pressure though the use of the solenoid valve 40 controlled by the control system. As illustrated in FIG. 5, the gas is discharged by the humidity controller 20 through the solenoid valve 40 and the humidity source 30, past the monitoring and control approaches 32 to flow over the deposition probe 12 and to increase the relative humidity around the probe 12 in such a manner as to effectuate the loading or deposition of deposition material.

As illustrated in FIG. 5, the second solenoid 42 may also draw gas from the gas source 38, but can route the gas through tubing 44 that goes around the plastic cartridge 36 and then to the monitoring and control apparatus 32. In this manner, dry gas may be delivered to the deposition probe 12. In some embodiments, the solenoid 42 can be controlled by the computer 22 and the monitoring apparatus 32 in such a manner that dry gas is mixed with humid gas to achieve a desired humidity level before reaching the probe 12. Furthermore, after deposition material is placed on the deposition probe 12 or the deposition substrate 25, the dry gas solenoid 42 may be used to blast dry gas over the deposition probe 12 to dry the deposition material on the deposition probe 12 or on the deposition substrate 25. As may be appreciated, the output from the solenoids 40, 42 may be routed through the monitoring apparatus 32 attached to the monitoring system 32 so to improve repeatability and optimal deposition conditions for various deposition materials. A numerical value may be assigned to each flow rate; monitoring and variations of this numerical value may aid in achieving desired humidity levels.

In alternative embodiments, a more sophisticated humidity generator may be utilized so that the precision and repeatability of the relative humidity surrounding the sample can be increased. In some embodiments, dry air may be continuously blown over the deposition probe 12, briefly stopped during the wet gas blast, and then immediately turned on again to minimize sample diffusion on a surface.

In some embodiments, a constant, humid environment may be adequate for sample loading and deposition. In such embodiments, the arrayer may include a plastic chamber or room that envelopes the deposition probe 12, the operative ends of the X, Y controller 14, and the X, Y translation stage 18, or the entire instrument. The chamber or room may be filled with a gas of the desired humidity for the duration of the loading and deposition program.

### Control Computer 22

With reference to FIGS. 1 and 2, an embodiment of the control computer 22 according to the present invention will now be described. The control computer 22 may be a standard computer utilizing a Pentium, Athlon, or other computer chip with a standard operating environment that includes a monitor, hard-drive, etc. In the illustrated embodiment of FIGS. 1-5, a standard data acquisition computer board commercially available from National Instruments, 11500 Mopac Expressway, Austin, Tex. 78759-3504, product number PCI-6025e, is utilized. Such an acquisition board may compile the necessary data to control the humidity, the height of the deposition probe 12, the relative positions of the Z controller 16, the X, Y controller 14, and the X, Y translation stage 18, and may also monitor the positions at which the deposition material is placed on the deposition substrate 25. Standard or customized software may be loaded onto the control computer 22, and may control the operation of the data acquisition board. Customizable software of particular use is available from LabView.

In addition to the computer controller 22, a stepper motor controller card (A-100 from Mill-Shaf Technologies, Inc.) may be utilized to control the fine action of the X, Y controller 14, the Z controller 16, and the X, Y translation stage 18. In some embodiments, the stepper motor controller card may also be controlled by the LabView (National Instruments) software or other software written by those skilled in the art.

### Force Feedback Monitor 50

The force feedback monitor 50 according to an embodiment of the present invention will now be described. As previously noted, the force feedback monitor 50 may be operably attached to the Z controller 16 and the control computer 22. The force feedback monitor 50 may be able, along with the control computer 22, to accurately recognize when the deposition probe 12 and the loading substrate 27, or the deposition probe 12 and the deposition substrate 25, touch. Knowing the exact moment of contact between the deposition probe 12 and the substrates 25, 27 may more accurately allow transferal of deposition material from the loading substrate 27 to the deposition probe 12 and from the deposition probe 12 to the deposition substrate 25. Force feedback monitors 50 coupled with the control computer 22 are known to those in the art for achieving such a result.

In alternative embodiments, the force feedback monitor 50 can also or instead be used to determine the initial relationship of the substrates 25, 27 and the deposition probe 12.

Utilizing the arrayer 10 according to some embodiments of the present invention, the probe 12 may be brought into contact with the substrate 25, 27 and then drawn back up by 1 mm or more before being exposed to humid gas from the humidity controller 20, which can cause a capillary bridge to form, thus loading or depositing the deposition material. Once the position of the substrate 25, 27 is determined relative to the deposition probe 12, the control computer 22 may simply bring the probe 12 to the desired level above the substrate 25, 27 for subsequent depositions without having to touch the surface of the substrate 25, 27.

Various types of force feedback monitors 50 useful for the above process are known to those skilled in the art.

One commercially available force feedback monitor 50 that can be used in some embodiments is an AFM head from a Dimension 3100 series scanning probe microscope available from Digital Instruments. Other force feedback monitors may be utilized by those of reasonable skill in the art without changing the nature and scope of the present invention. In the embodiment illustrated in FIGS. 1-5, read-out of the force feedback monitor 50 may be read through a standard break-out box and fed directly into LabView. In operation, a deflection value may be established as the threshold value at which LabView will stop the Z controller 14. Thus, once the surface is “found,” the arrayer 10 according to some embodiments of the present invention may be programmed to move the Z controller 14 to within 200 nm of the same position repeatedly. In this manner, the deposition probe 12 may approach and be retracted from the surface rapidly without the necessity of slowing and carefully counting steps until contact is made on each deposition cycle.

### Optical Microscope 52

With reference to FIG. 2, an optical microscope 52 according to an embodiment of the present invention will now be further described. As illustrated in FIG. 2, the optical microscope 52 can be mounted underneath the optical plate in an inverted position. The optical microscope 52 can allow the user to visualize the loading and deposition steps from below the deposition probe 12. Such monitoring may be within the resolution limits of the far field optics of a standard microscope that includes 10×, 20×, 40×, and 60× magnification options with a 10× eyepiece. In some embodiments, such a microscope may be fitted with a camera for image output to the control computer 22, to a separate monitor or to a recording device. As may be appreciated by those skilled in the art, the optical microscope 52 may be excluded from the present invention arrayer 10 without changing the nature and scope of the invention.

Although the deposition domains may be smaller than the wavelength of the light being used, they can be separated by distances on the order of 2 microns, allowing them to be separately observed by virtue of their optical characteristics. This is analogous to far field optical observation of sub-wavelength objects, such as individual DNA molecules and manometer scale colloidal metals by virtue of light collected from intercalated fluorophores or reflected photons, respectively. Thus, optical monitoring may be a useful method for preliminary evaluation of the deposition event as performed by an arrayer 10 according to embodiments of the present invention.

### Method of Use

The method of use of the arrayer 10 illustrated in FIGS. 1-5 will now be described. The Z controller 16 can be used to bring the deposition probe 12 into contact, or near contact, with the loading substrate 27. Contact force can be regulated by monitoring the cantilever deflection signal in, for example, LabView through the force feedback monitor 50. A blast of humid gas can then be utilized to create a capillary bridge between the deposition probe 12 and the loading substrate 27. This capillary bridge can transfer some amount of the deposition material to the deposition probe 12. The deposition probe 12 can then be withdrawn using the Z controller 16. The loading substrate 27 can then be moved by the X, Y translation stage 18 out of position beneath the deposition probe 12. The X, Y controller 14 can then move the deposition substrate 25 into position underneath the deposition probe 12. The deposition probe 12 can then be brought down into position by the Z controller 12 and the humidity cycle can be repeated to deposit the deposition material on the deposition substrate 25.

As may be appreciated, the above-described process of depositing deposition material may be carried out many times before the deposition probe 12 is significantly depleted of deposition material. Thus, in some embodiments one to several deposition domains for each array can be constructed after loading the probe 12 just one time. Each time a new deposition material is deposited, the deposition probe 12 can be cleaned. In some embodiments, the deposition probe 12 can be cleaned with a UV or ozone burst before loading a second deposition material.

In some embodiments by way of example, a sample of protein at a concentration of about 0.1 mg/ml in PBS (a buffered saline solution) may be deposited as a microdrop on a clean glass surface and dried to serve as the deposition materials/loading substrate. The deposition tool may be allowed to contact the dried microdrop and the humidity controlled to allow adsorption of protein to the deposition probe tip 13. This process can result in loading of the deposition tool with sufficient material for 10 to 100 deposition events. The loaded deposition probe 12 can then be utilized to deposit the PBS onto a freshly prepared gold or gold/alkanethiolate surface.

Each cycle of loading the deposition probe 12 and making one domain on the deposition substrate 25 may take as little as 1 minute. In addition, the actual deposition event can be relatively short, so the difference between making one and several spots with a single source material in some embodiments can be only a few seconds at most. Thus, to build one or many 10×10 molecular arrays of 100 different molecular species may take approximately 1 hour and 40 minutes in some embodiments. In alternative embodiments, this process may be further streamlined and scaled up to allow construction of much more complex arrays (hundreds to thousands of molecular species), and larger numbers of arrays in a similar time frame, without changing the nature and scope of the present invention. All of these steps may be coordinated through LabView utilizing the control computer 22.

In still further embodiments, there may be several X, Y translation stages 18 to bring loading substrates 27 into an operable position underneath the deposition probe 12. In this manner, multiple deposition materials can be accessed on the multiple loading substrates 27, allowing for the creation of a diverse array.

In some alternative embodiments, the optical microscope 52 may be utilized to locate registration marks for sample deposition in defined physical locations.

Also, in some embodiments, the deposition probe 12 may be washed using a microfabricated well with a simple fluidic feed. The washing solution (e.g., water) may be fed into the device, forming a protruding bubble held in place by surface tension. The deposition tool may then be washed in the bubble by piezo driven oscillation of the bubble in the deposition probe 12.

As will be appreciated by those skilled in the art, spot size can be a function of the radius of curvature of the deposition tool, tool and surface hydrophobicity/hydrophilicity, and control of humidity during the deposition event. Some embodiments of the present invention may allow spot sizes in the 200 nm diameter range (the tool radius can be 40 nm, in some embodiments) reproducibly when the appropriate parameters are carefully monitored. It is noteworthy that spots quite a bit smaller than this may be possible depending on the sample material and the purposes envisioned for the deposition domain.

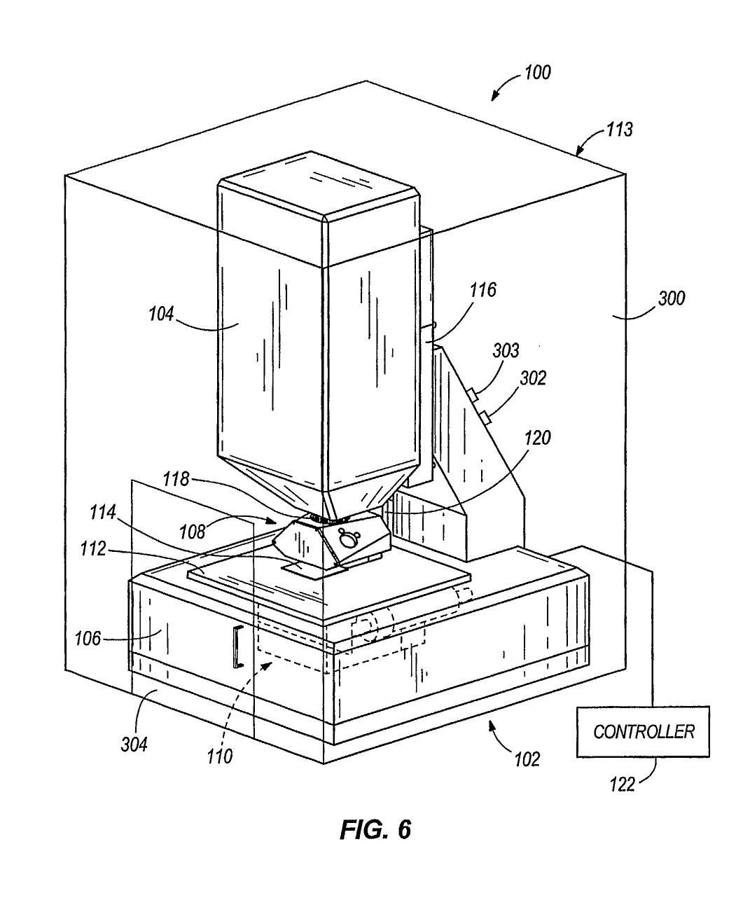

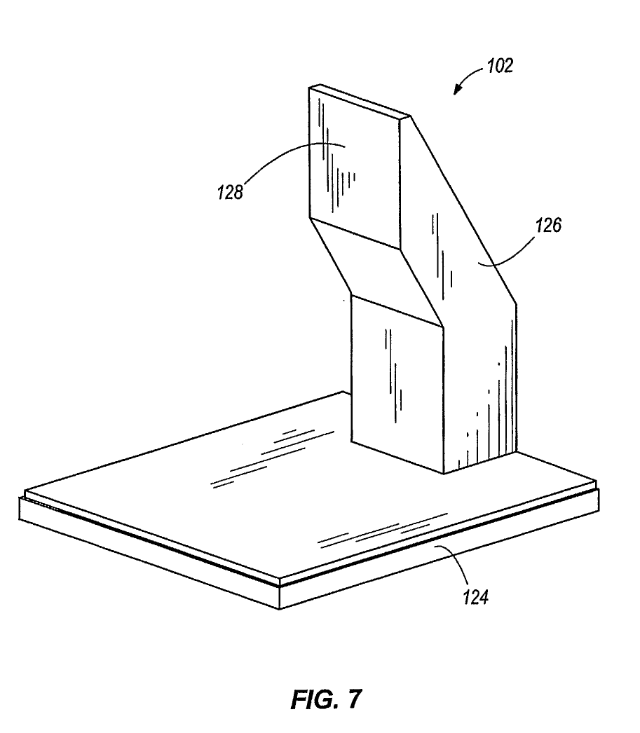

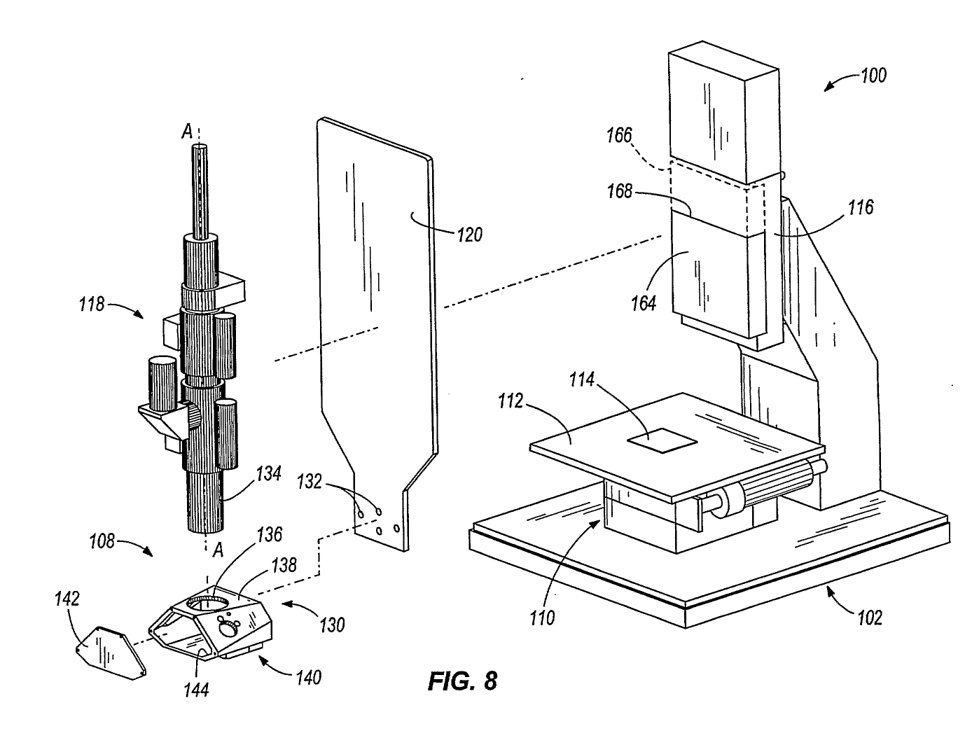

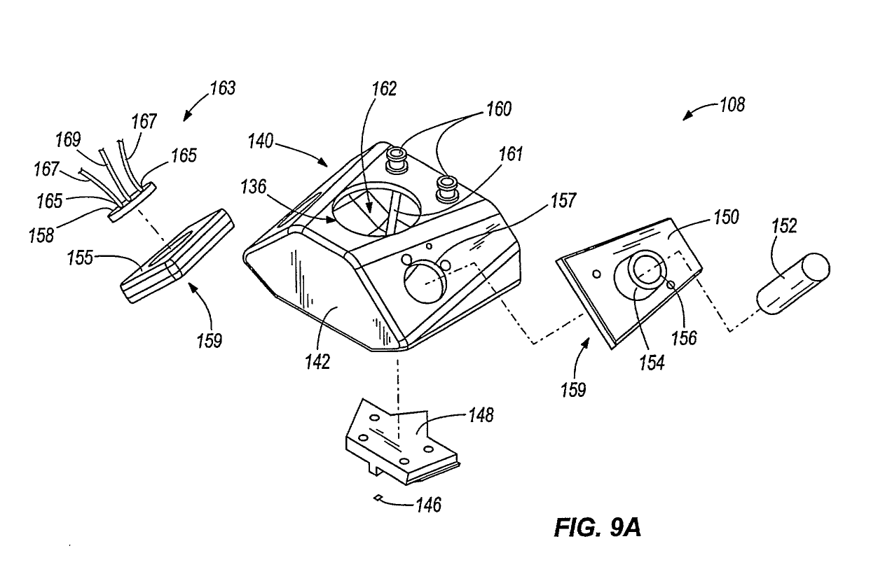

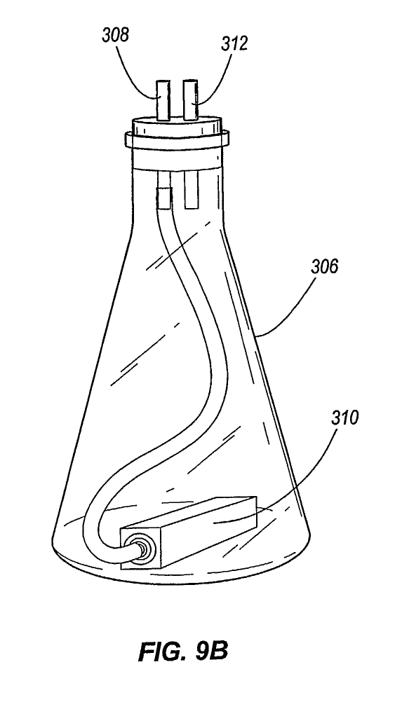

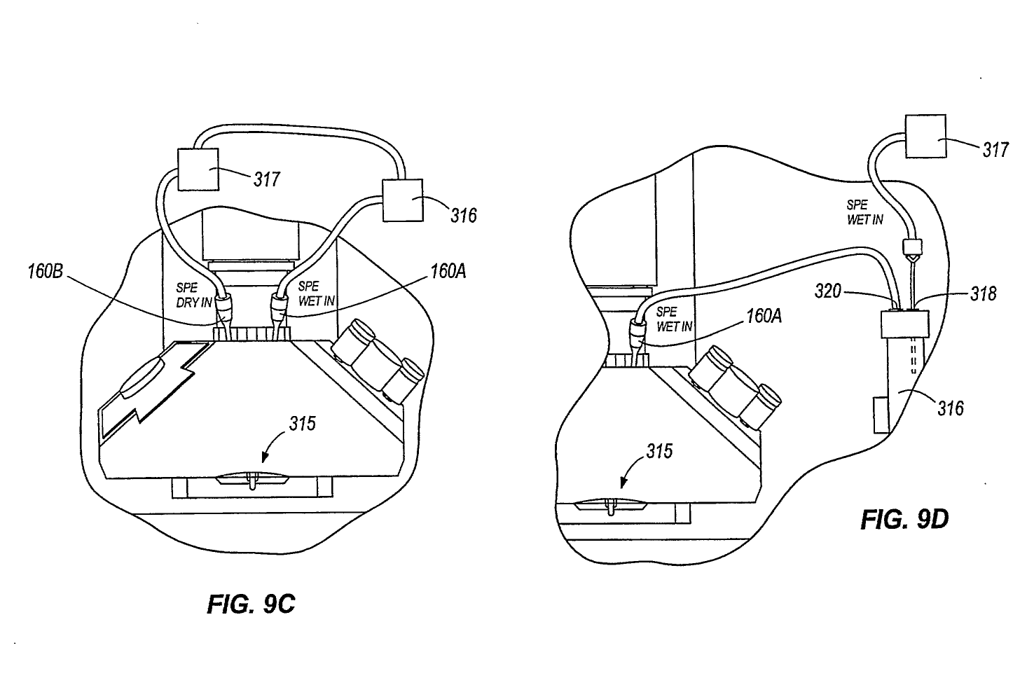

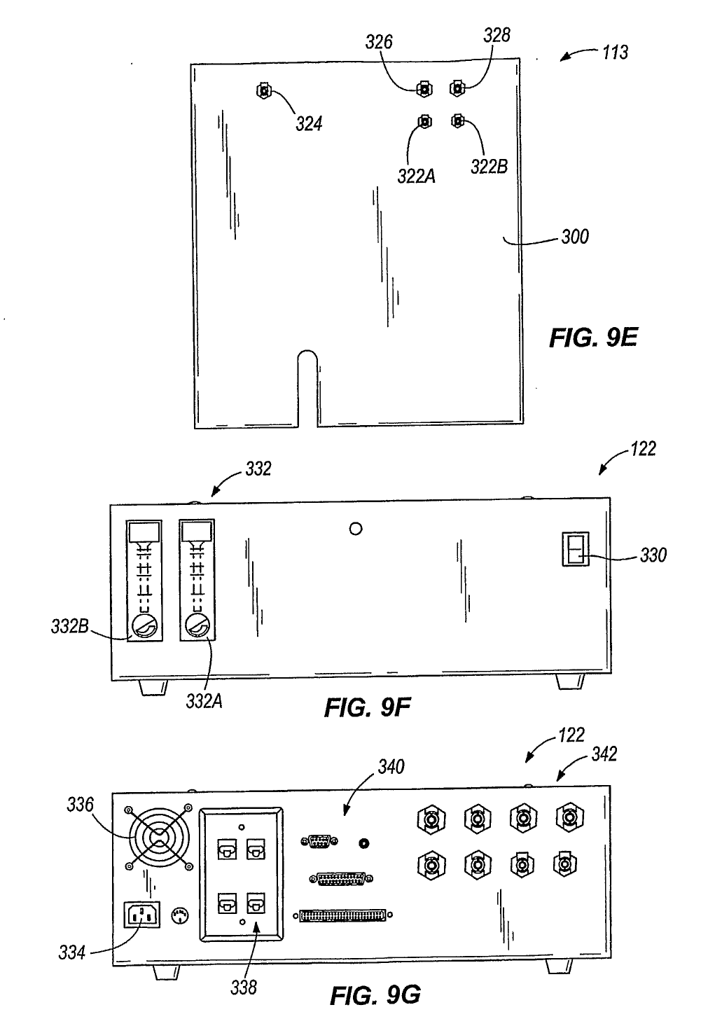

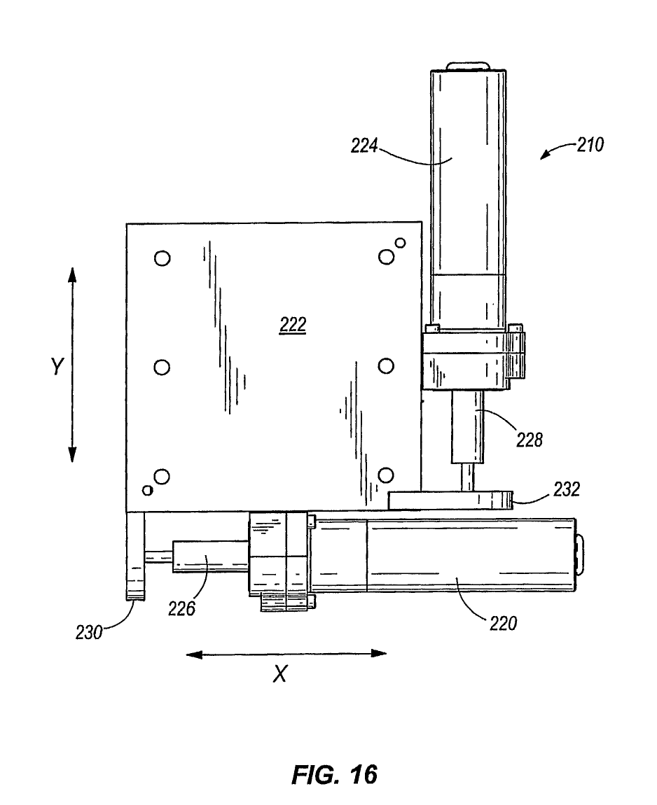

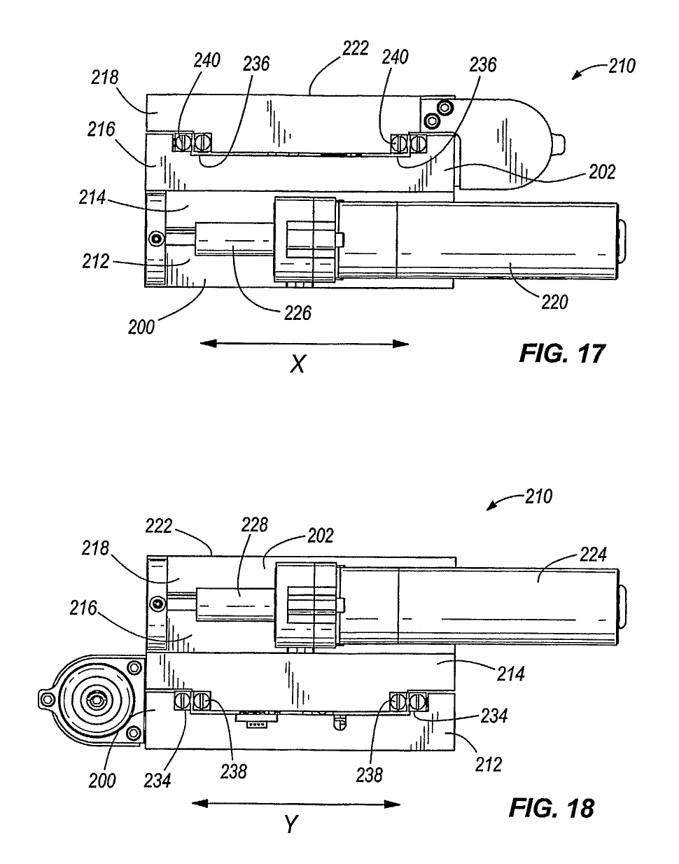

FIGS. 6-21 illustrate an arrayer 100 according to another embodiment of the present invention. As shown in FIG. 6, the arrayer 100 can include a support 102, a first cover 104, a second cover 106, a printhead 108 including a print tool 146 (see FIG. 9A), an X-Y-Z stage-positioning assembly 110 protected by the second cover 106, a stage 112 positioned to hold one or more substrates 114 and to allow movement of the substrate(s) 114 with movement of the stage 112, an environment control system 113, a Z printhead-positioning assembly 116, an imaging system 118, and a mounting plate 120 (see FIG. 8) to which the Z printhead-positioning assembly 116, imaging system 118, first cover 104, and printhead 108 are coupled.

A controller 122 (also sometimes referred to herein as “control computer”) can be connected to the arrayer 100 to control at least one of the printhead 108, the X-Y-Z stage positioning assembly 110, the environment control system 113, the Z printhead-positioning assembly 116, and the imaging system 118. Any number of devices can be used to control one or more of these elements, assemblies, and systems of the arrayer 100. In this regard, it should be noted that such devices can include microprocessor-based systems and other systems operable to execute software or other instructions. However, it should also be noted that such devices can include, without limitation, solid state and other electronic systems adapted to receive one or more signals and to generate control outputs accordingly, and need not necessarily execute software or other instructions. As used herein, the terms “controller” or “control computer” encompass all such devices. In other words, the controller 122 can include software-based and/or hardware-based components, and control of the arrayer 100 can be accomplished with software-based commands, hardware-based commands, or combinations thereof.

As used herein and in the appended claims, the term “arrayer” is used to refer to a device that is capable of depositing material onto a substrate in any patterned or patternless manner, including without limitation in a random or non-random manner, in any number of arrays, letters, words, symbols, and other graphics, in straight and/or curved lines, and the like. Also as used herein and in the appended claims, the terms “pattern” and “surface pattern” in their various forms do not alone indicate or imply the deposition of material in any particular manner (e.g., arrangement, format, and the like), and encompass deposition of material in any manner, including without limitation in a random or non-random manner, in any number of arrays, letters, words, symbols, and other graphics, in straight and/or curved lines, and the like.

As used herein and in the appended claims, the term “deposition material” (sometimes referred to herein and in the appended claims as simply “material”) is used to refer to the material or substance that is deposited onto a surface or substrate with an arrayer 10 or 100 of the present invention. The deposition material can include organic materials, inorganic materials, and combinations thereof. Organic materials can include, but are not limited to, cells, subcellular organelles, subcellular extracts, cell extracts, tissues, nucleic acids, PCR primers, DNA, RNA, proteins, antibodies, lipids, aptamers, carbon nanotubes, carbon nanoparticles, biochemicals, metabolites, extracellular matrix materials, or combinations thereof. Inorganic materials can include, but are not limited to, salts, adhesives, nanoparticles, dendrimers, catalysts, solvents, etchants, colloidal metals, colloidal ceramics, silica particles, metals, ceramics, polymers (e.g., monomers and/or copolymers, such as, block copolymers), or combinations thereof.

FIG. 7 shows one embodiment of the support 102, which can include a base 124. In some embodiments, the X-Y-Z stage-positioning assembly 110 can be directly or indirectly coupled to and supported by the base 124. For example, the X-Y-Z stage-positioning assembly 110 can be bolted, screwed, nailed, or clamped to the base 124, can be coupled to the base 124 by gravity or a magnetic force, frictional engagement of any type, adhesive or cohesive bonding material, can be coupled to the base 124 by a threaded or press-fit connection, or by inter-engaging elements, pins, or snap-fits, or can be coupled to the base 124 in any other manner.

The support 102 illustrated in FIG. 7 further includes an arm 126. The arm 126 extends vertically upward from the base 124, and includes a substantially vertically-oriented face 128. Various components of the arrayer 100 (e.g., the Z printhead-positioning assembly 116, as shown in FIGS. 6 and 8) can be coupled to the face 128. In other embodiments, one or more arms, plates, or other elements can extend to desired positions with respect to the base 124 (and/or other parts of the arrayer 100) in order provide any surface to which the Z printhead-positioning assembly 116 and other arrayer components can be coupled for support.

The support 102 can be formed of a variety of materials, including, without limitation at least one of granite, other stones, metals (e.g., aluminum, steel, invar, titanium, etc.), polymers (e.g., nylon, polypropylene, polycarbonate, polystyrene, etc.), and combinations thereof. In some embodiments, such as those employing polymers, the polymer can include internal and/or external supports and buttresses to provide desired structural rigidity and performance. The support 102 can be coupled to or can include structures necessary to isolate the arrayer 100 from external or environmental vibrations. For example, the support 102 can include an optical table, as described above, which can in turn be floated on pistons to minimize the transmission of vibrations to the arrayer 100.

FIG. 8 shows a partially exploded view of the arrayer 100 illustrated in FIG. 6, with some elements and features removed for clarity. As shown in FIG. 8, a substrate 114 is positioned on the stage 112. The substrate 114 can include one or more loading substrates and/or one or more deposition substrates. The number of substrates 114 positioned on the stage 112 can depend at least in part on the type of deposition being performed, the type of deposition material used, and the working area of the stage 112. By way of example only, in some embodiments, the working area of the stage 112 is about 200 mm×about 200 mm, while in other embodiments, the working area is about 100 mm×about 100 mm.

The type of substrate 114 used can vary depending at least in part upon the type of print tool 146 used, the type of deposition material used, and the desired surface pattern. The substrate 114, or portion thereof, onto which the deposition material is deposited can be two-dimensional (e.g., a surface of a glass slide) or three-dimensional (e.g., a polymer matrix). Also, the substrate 114 can include a variety of base materials, including transparent materials, translucent materials, opaque materials, or combinations thereof. For example, the substrate 114 can include, but is not limited to glass, quartz, ruby, diamond, plastics, elastomeric materials, ceramics, silicon, silicon dioxide, silicon nitride, metal, silicon, semiconductor materials, mica, muscovite mica, or combinations thereof. Silicon base materials can include an etched pattern that at least partially defines the resulting surface pattern.

The substrate 114 can include a base material alone or can include a surface treatment or coating applied to or coupled to a base material to enhance positioning and/or binding of deposition material to the substrate 114. A variety of chemistries can be used for the coating or surface treatment. The type of coating or surface treatment used can depend at least in part on the type of deposition material used, the desired surface pattern, and the type of print tool 146 used. Coatings or surface treatments can include, but are not limited to, at least one of oligonucleotides, poly-l-lysine, amino-silanes, epoxy-silanes, aldehyde-silanes, NHS-esters, peptides, antibodies (e.g., for antibody-based capture assays), hydrogels, polymer matrices, metals (e.g., gold, silver, platinum, titanium, nickel, or any other suitable metals), polydimethyl siloxane (PDMS), Advanced Protective Technology for Engineering Structures (APTES) treatments (e.g., on muscovite mica), nitrocellulose (e.g., FAST™ slides, available from Whatman Schleicher & Schuell BioScience, which include glass slides coated with a proprietary nitrocellulose polymer, and PATH™ slides, available from GenTel Biosurfaces, which include a proprietary ultra-thin nitrocellulose film), lipids, biomembranes, cellular surfaces, and any other coating or surface treatment suitable to the deposition material of interest.

The substrate(s) 114 can be coupled to the stage 112 in a number of different manners, including, without limitation, one or more fasteners (e.g., clips, pins, clamps, nails, screws, bolts, rivets, magnets and the like), adhesive or cohesive bonding material (e.g., tape, such as double-sided Scotch tape, available from 3M), or any combination thereof. For example, in some embodiments, one or more magnets can be embedded in the stage 112 (such as by forming one or more recesses in an underside of the stage 112 and housing magnets in the recesses). In such cases, the substrate(s) 114 positioned on the stage 112 can include a ferrous bottom coating to allow the substrate(s) 114 to be coupled to the stage 112 with magnetic force. Also in such embodiments, the magnet(s) can be positioned strategically with respect to the stage 112 to allow proper positioning of the substrate(s) 114. In some embodiments, the magnet(s) can include electromagnets so that the magnetism can be controlled to be effective only when needed. Still other manners of coupling one or more substrates 114 to the stage 112 are possible, and fall within the spirit and scope of the present invention.

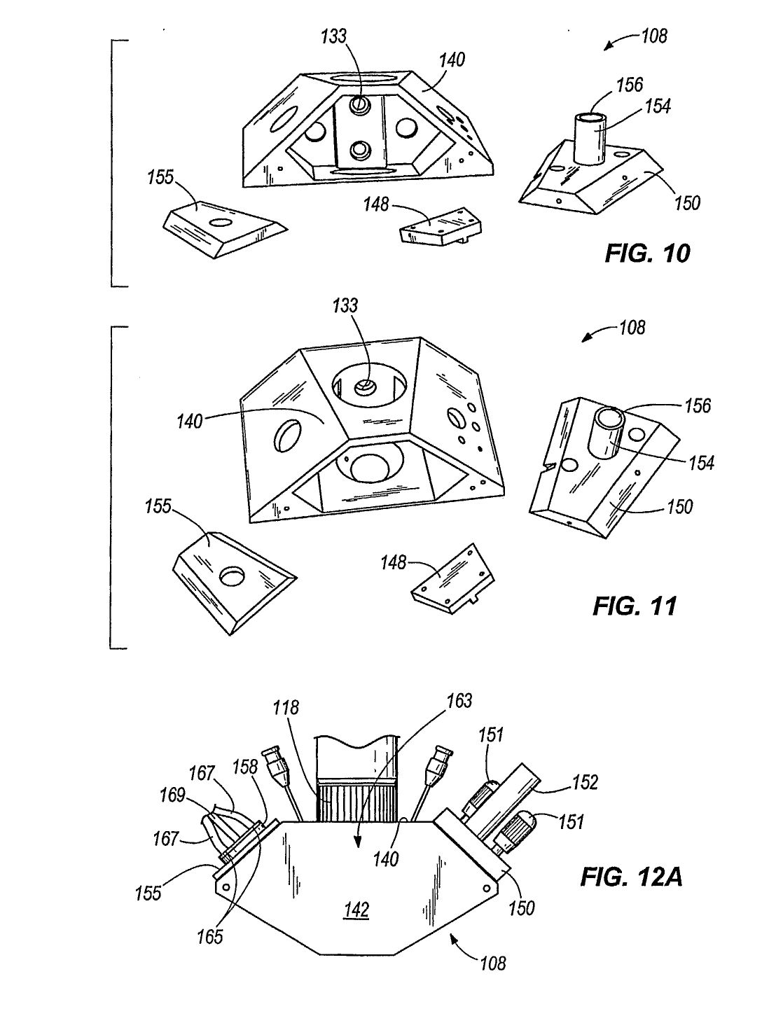

As also shown in FIG. 8, in some embodiments the imaging system 118 and/or a rear portion 130 of the printhead 108 can be coupled to the mounting plate 120. By way of example only, the mounting plate 120 is shown in FIG. 8 as having bolt holes 132 dimensioned to receive bolts (not shown) for coupling the rear portion 130 of the printhead 108 to the mounting plate 120. The bolt holes 132 on the mounting plate 120 can be positioned and sized to mate with corresponding bolt holes 133 on the rear portion 130 of the printhead 108 (see FIG. 10). However, it should be understood that the printhead 108 can be coupled to the mounting plate 120 in any other manner, including those described above with reference to the connection between the X-Y-Z stage-positioning assembly 110 and the base 124.

In some embodiments, the imaging system 118 can include an optical microscope and/or a camera or other recording device (not shown). One example of a camera that can be used with the present invention is a DXC-LS1 ¼″ Hyper HAD CCD Color Lipstick Camera (available from Sony) with a 768×494 pixel resolution, digital zoom up to 3×, and National Television Systems Committee (NTSC) output via an S-video cable. If desired, a monitor or other display device can be coupled to the microscope, camera and/or other recording device to display images to a user. As shown in FIG. 8, the imaging system 118 can be positioned above the printhead 108 to image a deposition process. The imaging system 118 can include a portion 134 dimensioned to be received within an aperture 136 in an upper surface 138 of the printhead 108. In the embodiment illustrated in FIG. 8 by way of example only, the portion 134 is cylindrical, and has a smaller diameter than that of the aperture 136. Accordingly, the portion 134 can be moved relative to the aperture 136 to properly image the deposition process. For example, in some embodiments, the imaging system 118 can be pivoted relative to a longitudinal axis A-A of the imaging system 118, can be moved into and out of the aperture 136, can be moved side-to-side and back-and-forth relative to the aperture 136, or in any combination thereof.

In some embodiments, the printhead 108 includes a housing 140, which can have a cover 142 dimensioned to at least partially cover an open portion 144 (e.g., an open front portion 144 in the embodiment illustrated in FIG. 8) of the housing 140. In the embodiment illustrated in FIG. 8, the housing 140 and the cover 142 are separate parts, but in some embodiments (see, for example, FIG. 9A), the housing 140 can be integrally formed with the cover 142.

FIG. 9A illustrates an embodiment of the printhead 108 in greater detail. The printhead 108 includes the print tool 146 (also referred to herein as a surface patterning tool, abbreviated “SPT”), which in some embodiments can be microfabricated. The SPT 146 can be used to deposit material onto one or more substrates 114. In some embodiments, the SPT 146 can also load materials from one or more substrates 114 onto the SPT 146. The SPT 146 can be coupled to a print tool holder 148, which can be configured to hold multiple SPTs 146. The print tool holder 148 can be coupled to the housing 140 of the printhead 108. Also, the print tool holder 148 can be dimensioned to be coupled to the housing 140 in such a way that the SPT 146 is properly positioned for deposition, and in some cases such that the SPT 146 is properly positioned for detection by a laser or other type of sensing system 159, described below.

The print tool holder 148 can be coupled to the housing 140 in a variety of different manners, including, but not limited to one or more fasteners (e.g., one or more bolts, screws, nails, clamps, clips, rivets, brads, pins, and combinations thereof), magnetic force, gravity, frictional engagement, adhesive or cohesive bonding material (e.g., tape, such as double-sided Scotch tape, available from 3M), a threaded or press-fit connection, one or more inter-engaging elements (e.g., snap-fits), or any other suitable manner for coupling the print tool holder 148 to the housing 140. Similarly, the SPT 146 can be coupled to the print tool holder 148 in a variety of different manners, including, but not limited to, any of the manners mentioned above with regard to the connection between the print tool holder 148 and the housing 140.

In some embodiments, the printhead 108 further includes one or more sensing systems 159, including, without limitation, at least one of a force feedback system (e.g., an optical lever system that includes an electromagnetic radiation source and position-sensitive photodetecor), any other optical sensing system, a capacitance sensing system, a resistance sensing system, an inductance sensing system, a conductance sensing system, a pressure sensing system, and any combination thereof. Examples of an optical sensing system include, but are not limited to, observation of material deposition (e.g., spot and/or line formation), pattern recognition, machine vision, birefringence, interferometry, and combinations thereof.

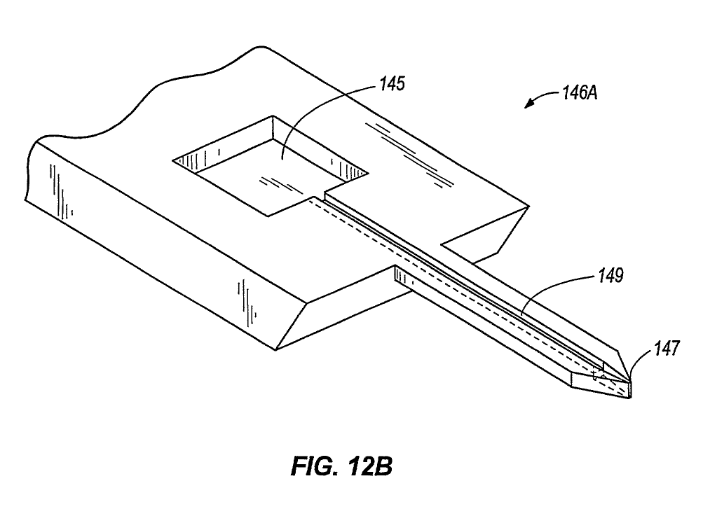

By way of example only, the illustrated arrayer 100 has a force feedback sensing system 159 that employs an optical lever system 163 (see FIGS. 9A and 12A). The optical lever system 163 includes an electromagnetic radiation source and a position-sensitive photodetector. One embodiment of the optical lever system 163 is described below with reference to FIG. 9A, but it should be understood that this illustration and description are provided by way of example only, and the optical lever system 163 can include any suitable electromagnetic radiation source and any suitable radiation-sensitive detector to sense the position of the SPT 146 and control the deposition process. For example, the electromagnetic radiation source can include, but is not limited to, a laser, a super luminescent diode (e.g., a super luminescent diode available from the Laser Group of Hamamatsu Corporation), and a combination thereof.

The printhead 108 can also include components necessary to house or support various portions of one or more sensing systems 159. For example, the printhead 108 illustrated in FIG. 9A includes a laser positioning device 150, which is dimensioned to couple a laser 152 to the housing 140. The laser positioning device 150 shown in FIG. 9A includes a collar 154 that defines an aperture 156 dimensioned to receive the laser 152 (although any other suitable structure for retaining the laser 152 in a desired position with respect to the housing 140 can instead be employed). The laser 152 can take any form desired. By way of example only, in some embodiments the laser 152 is a laser diode. Also by way of example only, in some embodiments, the laser 152 can include, but is not limited to, a 763 nm 0.5-5 MW red laser, a 633 nm red diode laser, and a combination thereof.

The housing 140 can also include a second aperture 157 positioned adjacent the collar 154 when the laser positioning device 150 is in an assembled state. The second aperture 157 allows the laser 152 to emit a laser beam into the interior of the housing 140. In some embodiments, the collar 154 or other structure retaining the laser 152 in position with respect to the housing 140 can be part of the housing 140, rather than a separate element or structure permanently or releasably attached to the housing 140.

The laser positioning device 150 can be a stationary, structural component used to couple the laser 152 to the printhead 108. Alternatively, the laser positioning device 150 can be a controllable and manipulatable unit. For example, in some embodiments, the laser positioning device 150 includes a goniometer that can be positioned locally and manually (e.g., by positioning knobs 151, shown in FIG. 12A), by a local controller (not shown) or by the controller 122 shown in FIG. 6. The laser positioning device 150 and the laser 152 can be coupled together in any suitable manner, including any of the manners described above with reference to the connection between the X-Y-Z stage-positioning assembly 110 and the base 124.

The printhead 108 can further include a detector positioning device 155 to which a detector 158 can be coupled. The detector positioning device 155 and detector 158 can be positioned on a side of the housing 140 suitable for detecting various information from the laser 142 regarding the position of the SPT 146. The detector positioning device 155 and the detector 158 can be coupled together in any manner, including those described above with reference to the connection between the X-Y-Z stage-positioning assembly 110 and the base 124.

In the optical lever system 163 illustrated in FIGS. 9A and 12A, the laser 152 (or other suitable electromagnetic radiation source) is directed to and reflected off of the SPT 146 (e.g., the back of the SPT 146, near its point of attachment, if a cantilever type SPT 146 is used), and received or collected by the detector 158. In the illustrated embodiment of the optical lever system 163, the detector 158 includes a split photodiode detector which includes two closely spaced photodiodes 165 (otherwise referred to herein as two halves 165 of a split photodiode), the output of which is collected by a differential amplifier (not shown). As a result, the illustrated detector 158 include three output wires: two outer wires 167 corresponding to the two halves 165 of the split photodiode, and a center wire 169 for grounding.

The laser/beam deflection path can be initially directed to the center of the split photodiode such that each of the two halves 165 of the split photodiode receive equal (i.e., half) of the total reflected light. Displacement (e.g., angular displacement) of the SPT 146 can cause one half 165 of the split photodiode to receive more electromagnetic radiation that the other half 165, resulting in an output signal (e.g., the difference value between the two halves normalized by their sum) that is proportional to the deflection of the SPT 146. Two types of information can result from the optical lever system 163: a sum and a difference. The sum value is the total amount of electromagnet radiation striking the detector 158, whereas the difference value is the difference between the two halves 165 of the split photodiode, normalized by their sum. Rapid changes to the sum and/or difference values can be indicative of displacement of the SPT 146, and can result from a contact or interaction between the SPT 146 and a substrate 114 from which the SPT 146 is loading a material, or onto which the SPT 146 is depositing a material.

In some embodiments, a surface-induced deflection of the SPT 146 moves the reflected beam from front to back along the left side of the interior of the printhead 108 (when viewed as shown in FIG. 12A). In such embodiments, it can be important to keep the three output wires 167 and 169 substantially parallel to the path of beam deflection to ensure that beam deflection will be substantially perpendicular to the split between the two halves 165 of the split photodiode, which maximizes the sensitivity of the detector 158.

The laser 152, laser positioning device 150, detector positioning device 155, and detector 158 (if employed) make up part of the surface sensing system 159 used for detecting deflection of the SPT 146 when the SPT 146 contacts or interacts with a substrate 114 or material on the substrate 114. In some embodiments, the controller 122 can control the relative positions of the laser 152 and/or the detector 158. Also, in some embodiments, based at least in part upon the signals received by the controller 122 from the detector 158, the controller 122 can control the positioning of the print tool holder 148 to alter the position of the SPT 146 relative to the substrate 114. In addition, in some embodiments, based at least in part upon the signals received by the controller 122 from the detector 158, the controller 122 can control the Z printhead-positioning assembly 116 to alter the position of the SPT 146 relative to the substrate 114. Also, in some embodiments, based at least in part upon the signals received by the controller 122 from the detector 158, the controller 122 can control the X-Y-Z stage-positioning assembly 110 to alter the position of the stage 112, and accordingly, the position of the substrate 114 to alter the relative position between the SPT 146 and the substrate 114.

In some embodiments, the printhead 108 can further include one or more nozzles 160 that define air or gas inlets into an interior space 162 of the housing 140. The nozzles 160 can allow a humidity source or other environment controlling device to be fluidly connected to the interior space 162 of the housing 140 in order to create a desired local deposition environment surrounding or proximate the SPT 146. As shown in FIG. 9A, the nozzles 160 can be fluidly connected to tubing 161 or any other type of conduit that can direct air or gas to the environment of the SPT 146. The environment control system 113 can include or be coupled to the nozzles 160.

FIGS. 9B-9G illustrate various portions of one embodiment of the environment control system 113. Environment control can be critical for successful and reproducible surface patterning. Ambient room temperature and humidity can affect a variety of surface pattern parameters, including, but not limited to, one or more of spot size, line thickness, precision, reproducibility, and spatial resolution. The environment control system 113 includes an enclosure 300, as shown in FIG. 6, a temperature sensor 302, and a humidity sensor 303, and a control feedback loop that can be controlled by the controller 122, or a portion thereof, or a separate local controller. The environment control system 113 can include two levels of environment control: global (i.e., control of the environment surrounding a portion of the arrayer 100 involved in the surface patterning process, or surrounding various components involved in moving the stage 112, the substrates 114, the printhead 108, and/or the imaging system 118), and local (i.e., control of the environment surrounding the SPT 146). Local environment control is sometimes referred to herein as control of the sample point environment (SPE).

The enclosure 300 surrounds a portion of the arrayer 100 and is coupled, directly or indirectly, to the support 102. In some embodiments, the enclosure 300 forms part of the support 102. In the embodiment illustrated in FIG. 6, the enclosure 300 surrounds the support 102, the Z printhead-positioning assembly 116, the imaging system 118, the mounting plate 120, the X-Y-Z stage-positioning assembly 110, the substrates 114, and the printhead 108. However, it should be understood that the enclosure 300 can be used to enclose any portion of the arrayer 100 necessary. The enclosure 300 can be sealed to optimize environment control performance. The enclosure 300 can be formed of a variety of materials, including, without limitation, one or more of glass, plastic, ceramic, metal, a composite, or any other suitable material that will allow for accurate environment control of the respective portion of the arrayer 100 enclosed within the enclosure 300. The enclosure 300 can be formed of transparent materials, translucent materials, opaque materials, or a combination thereof. The enclosure 300 can include a door 304 dimensioned to allow access to the interior of the enclosure 300 for initial setup of substrates 114, deposition materials, the SPT 146, the imaging system 118, and any other portion of the arrayer 100. After the arrayer 100 has been set up and the door 304 closed, manipulations of the portion of the arrayer 100 enclosed within the enclosure 300 can be made via any number of ports (e.g., iris side ports, or any other suitable port that minimizes disruption of the environment within the enclosure 300), without disturbing the global environment within the enclosure 300. Various aspects of the environment can be controlled using the environment control system 113, including, but not limited to, at least one of temperature, pressure, humidity, sound, light, and any other environmental parameter that may affect the surface patterning process. Humidity has been shown to be of particular importance in surface patterning. As a result, temperature and humidity will be the primary environmental parameters discussed herein.

The temperature sensor 302 and the humidity sensor 303 can be coupled to any portion of the arrayer 100, within the enclosure 300. For example, the temperature sensor 302 and the humidity sensor 303 can be coupled to the support 102, as shown in FIG. 6. Output voltages from the temperature sensor 302 and the humidity sensor 303 can be converted into temperature and relative humidity values by the controller 122, or a portion thereof, or a local controller. In some embodiments, humid gas for the environment within the enclosure 300 is generated by circulating gas from inside the enclosure 300 through a humidity source 306 (see FIG. 9B), and returning it to the enclosure 300. In some embodiments, humid gas can be generated by routing gas from a gas source (e.g., a gas tank of nitrogen or argon) through the humidity source 306 and into the enclosure 300, instead of or in addition to re-circulating gas from within the enclosure 300 through the humidity source 306.

In some embodiments, as shown in FIG. 9B, the humidity source 306 includes a flask that contains double deionized water (sometimes referred to as a “ddiH₂O bubbler flask”). Relative humidity levels in the enclosure 300 can reach about 75% or more. The controller 122 can be configured to monitor and control the temperature and humidity within the enclosure 300 via the temperature sensor 302 and the humidity sensor 303, and automatically start or stop a pump, gas tank regulator, open or close a valve, or any other suitable action to control the flow of humid gas into or out of the enclosure 300. The humidity source 306 shown in FIG. 9B includes an inlet 308, a diffuser 310 (e.g., an air stone) positioned inside the humidity source 306, and an outlet 312. Gas from within the enclosure 300 can be routed into the humidity source 306 via the inlet 308, into the humidity source 306, out the outlet 312 of the humidity source 306, and into a humid gas inlet 324 on a back wall of the enclosure 300, shown in FIG. 9E.

Dry gas can be directed into the enclosure 300 via a dry gas inlet 326. In some embodiments, as mentioned above, the dry gas inlet 326 can be in fluid communication with a dry, inert gas. Based on feedback from the humidity sensor 303, the controller 122 (or a local controller) can monitor the humidity within the enclosure 300 and open or close a valve (e.g., a solenoid valve) in fluid communication with the dry, inert gas to start or stop, respectively, dispensing of the dry inert gas into the enclosure 300. Dispensing of humid or dry gas into the enclosure 300 can be done in a pulsing mode, a continuous mode, or a combination thereof. A user can set (e.g., via a graphical user interface) which mode should be used for a particular application. As shown in FIG. 9E, an outlet 328 can be used to release pressure from within the enclosure 300 to direct dry gas, humid gas, or a combination thereof from out of the enclosure 300.

As mentioned above, the environment control system 113 can further control the local environment surrounding the SPT 146 (or “sample point environment,” generally indicated by reference numeral 315) for precise control of deposition and surface patterning conditions. As described above with reference to FIG. 9A and further illustrated in FIG. 9C, the printhead 108 can include one or more nozzles 160. In the embodiment illustrated in FIG. 9C, the printhead 108 includes a first nozzle 160A, and a second nozzle 160B. The first nozzle 160A can be used to direct humid gas to the sample point environment 315, and the second nozzle 160B can be used to direct dry gas to the sample point environment 315.

The first nozzle 106A can be fluidly coupled to a gas source 317, with a humidity source 316 (see also FIG. 9D) in fluid communication between the gas source 317 and the first nozzle 160A. The gas source 317 can include a variety of suitable sources of gas, including, but not limited to air, a dry, inert gas (e.g., a gas tank of nitrogen or argon), or combinations thereof. Humid gas for the sample point environment 315 can be generated by routing gas from the gas source 317 through the humidity source 316, prior to being directed to the sample point environment 315. In some embodiments, as shown in FIG. 9D, the humidity source 316 includes a flask that contains double deionized water (sometimes referred to as a “ddiH₂O bubbler flask”). As shown in FIG. 9D, the humidity source 316 includes an inlet 318 and an outlet 320, the inlet 318 being fluidly coupled to the gas source 317, and the outlet 320 being fluidly coupled to the first nozzle 160A. In some embodiments, the humidity source 306 can be positioned within the enclosure, as shown in FIG. 9D.

As shown in FIG. 9C, dry air or gas can be directed to the sample point environment 315 by fluidly coupling the second nozzle 160B directly to the gas source 317. In some embodiments, as shown in FIG. 9C, the same gas source 317 as that used for humid gas is coupled to the second nozzle 160B. In some embodiments, a separate gas source is coupled to the second nozzle 160B. The first and second nozzles 160A and 160B can be connected to the gas source 317 via connections 322A and 322B, respectively, on the inside back wall of the enclosure 300, as shown in FIG. 9E.

The controller 122 can include or be connected to the environment control system 113. By way of example only, one embodiment of a portion of the controller 122 is illustrated in FIGS. 9F and 9G. As shown in FIG. 9F, the front of the controller 122 includes a power switch 330, and two flow control valves 332. The flow control valves 332 control the velocity of gases at the sample point environment 315. A first flow control valve 332A controls the velocity of humid gas flowing to the sample point environment 315, and a second flow control valve 332B controls the velocity of dry gas flowing to the sample point environment 315. Such flow control valves can include a variety of valves known in the art, including, but not limited to solenoid valves. The flow control valves 332 can control the flow of dry and humid gas to the sample point environment 315, similar to that illustrated in FIG. 5 and described above. In some embodiments, velocity values range from 0 liters per minute (LPM) to about 0.5 LPM. In embodiments, both humid and dry gas moves to the sample point environment at a flow rate of about 0.1 LPM. At greater velocities, depending on the type of SPT 146 used, airflow across the SPT 146 can cause bending (e.g., if the SPT 146 includes a cantilever-type SPT 146) of the SPT 146, and cause fluctuations in the signal detected by the detector 158. Dispensing of humid or dry gas to the sample point environment 315 can be done in a pulsing mode, a continuous mode, or a combination thereof. A user can set (e.g., via a graphical user interface) which mode should be used for a particular application. In some embodiments, pulses are used to precisely control the local environment of the SPT 146. In some embodiments, a continuous or override mode can be selected for one or both of humid and dry gas directed to the sample point environment 315.

In the embodiment illustrated in FIG. 9G, the back of the controller 122 includes a variety of connections to and from the gas source 317, the humidity source 306, the enclosure 300, and a variety of other components. As shown in FIG. 9G, the controller 122 can monitor and control the level of humidity both on a global level, and on a local level. The controller 122 includes a power connection 334, a fan 336, a plurality of sensor and motor connections 338 for the sensing system 159, connections 340 to other controller components of the arrayer 100, other components of the controller 122, or local controllers that function in conjunction with the controller 122, and a variety of connections 342 that correspond to other components and connections of the environment control system 113 to allow the controller 122 to monitor and control the global and local environment of the arrayer 100 and the SPT 146, respectively.

The humidity sources 306 and 316 shown in the illustrated embodiment each include a ddiH₂O bubbler flask, as describe above. However, a variety of suitable humidity sources can be used without departing from the spirit and scope of the present invention

In some embodiments, as described above with respect to the arrayer 10, controlling the local humidity surrounding the SPT 146 can control one or more of loading and deposition processes. However, in some embodiments, the deposition material can include a buffered solution. In some embodiments, the buffered solution can include glycerol and a surfactant that does not dry out or require humid gas to rehydrate it. For example, in some embodiments, a protein to be deposited can be present in a solution containing glycerol at a concentration of about 0.1 mg/mL, and can be deposited as a drop (e.g., a microdrop). In this example, humid gas is not required at the sample point environment 315, because the glycerol-containing deposition material will not dry under the deposition conditions. Other surfactants can be used in other embodiments.

FIGS. 10-12 show alternative embodiments of the printhead 108 from different perspectives. FIGS. 10 and 11 show exploded views of embodiments of the printhead 108, and FIG. 12A shows an assembled view of an embodiment of the printhead 108. Specifically, FIG. 12A illustrates a housing 140, a cover 142, an imaging system 118, a detector 158, a laser positioning device 150 including positioning knobs 151, and a laser 152 as assembled in one embodiment of the printhead 108.

The printhead 108 can be formed of a variety of materials or combinations of materials. In some embodiments, various components of the printhead 108 are formed of a polymer (e.g., nylon, UHMW, and the like), including without limitation the housing 140, the cover 142, the print tool holder 148, the laser positioning device 150, the detector positioning device 155, and/or the nozzles 160. In some embodiments, some components of the printhead 108 that are formed of a polymer can be constructed using rapid prototyping. Rapid prototyping allows the creation of convoluted structures, undercuts, or internal structures that are difficult or impossible to achieve with conventional machining or molding techniques. Some types of rapid prototyping include a layer-by-layer polymerization of liquid or granular solid polymeric materials to form three-dimensional structures. In some embodiments, each layer of a part formed by rapid prototyping may be a few microns or less in thickness.

Some types of SPTs 146 yield enhanced results over other types of SPTs, depending upon the substrate 114 on which the deposition material is to be deposited, and/or upon the type of deposition material used. The best type of SPT 146 for a particular application can be determined empirically. The present invention can include a variety of types of SPTs 146, and any suitable SPT 146 can be used without departing from the spirit and scope of the present invention.

The SPT 146 can be a cantilever type SPT, a non-cantilever type SPT, or a combination thereof. A cantilever type SPT can include a back-loaded deposition tool (e.g., a quill-type deposition tool 146A, such as that illustrated in FIG. 12B, a nanopipette, or a front-loaded deposition tool (e.g., the deposition probe 12 described above and illustrated in FIG. 4), or a combination thereof. In addition, a non-cantilever type SPT can include, but is not limited to, pores, flexure systems, and combinations thereof.

In embodiments employing a back-loaded deposition tool, the SPT 146 either includes or is in fluid communication with a reservoir or source containing material to be deposited. For example, with reference to FIG. 12B, the SPT 146A can include a reservoir 145 that is in fluid communication with a tip 147 of the SPT 146A. The SPT 146A can be loaded with a deposition material by transferring (e.g., via a pipette) a deposition material to the reservoir 145, and the material properties of the SPT 146A can allow for migration of the deposition material to a tip 147 of the SPT 146A for deposition onto a substrate 114. In some embodiments, as shown in FIG. 12B, the SPT 146A can further include a channel 149 that allows fluid migration from the reservoir 145 to the tip 147 of the SPT 146A. In some embodiments, the surface properties of the SPT 146A govern fluid migration of the deposition material to the tip 147 of the SPT 146A. In embodiments employing a front-loaded deposition tool, the SPT 146 loads material from a source (e.g., a first substrate 114 or a first portion of a substrate 114), and deposits that material at a destination (e.g., onto a second substrate 114 or second portion of a substrate 114).

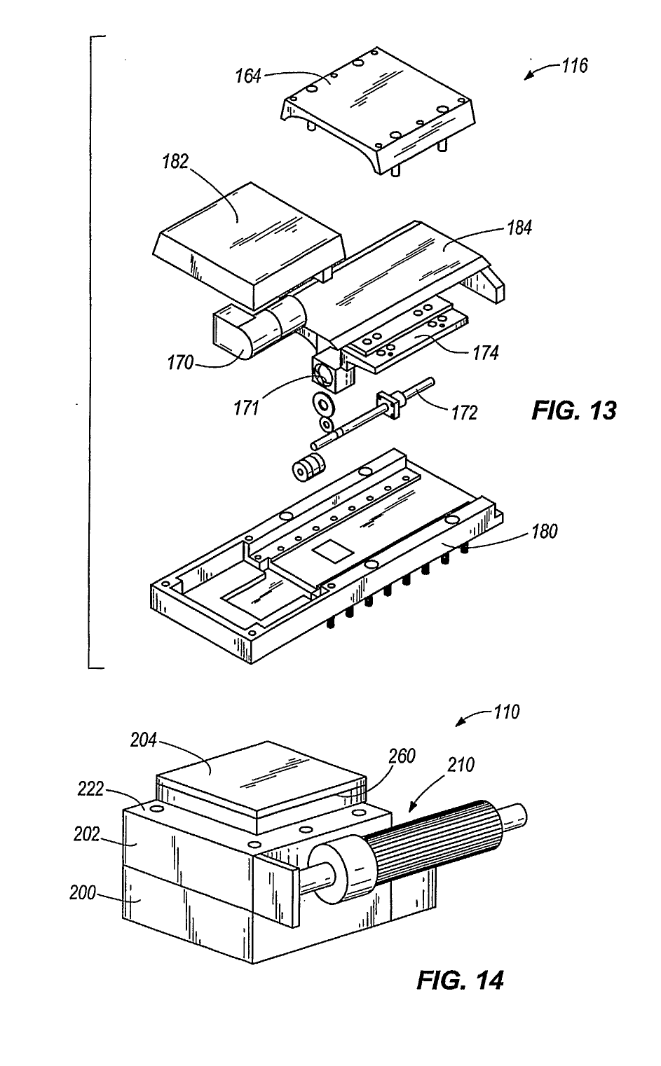

With continued reference to FIG. 8, the mounting plate 120 (to which the imaging system 118, the first cover 104, and/or the printhead 108 of the illustrated embodiment can be coupled as described above) can be coupled to the Z printhead positioning assembly 116. Specifically, in the illustrated embodiment, the mounting plate 120 is coupled to a movable plate 164 of the Z printhead positioning assembly 116. The movable plate 164 can be continuously movable between an upper position 166 (shown in dashed lines in FIG. 8), and a lower position 168 (shown in solid lines in FIG. 8). A number of different types of actuators can be utilized for moving the movable plate 164. The movable plate 164 can be moved in a variety of different manners known to the art, such as by an actuator 170 as shown in FIG. 13, and as will now be described.

The actuator 170 can take a number of different forms that allow motion control in increments of between about 200 nm and several microns, including without limitation a servo motor, a stepper motor, and the like. In other embodiments, actuators capable of greater precision are possible and can be used, including without limitation the types of actuators described below with reference to the X-Y-Z stage-positioning assembly 110. In the embodiment shown in FIG. 13, the actuator 170 is coupled to and rotates a ball screw 172 threaded within a threaded aperture 171 (e.g., of a fixed nut, boss, wall or other part) coupled to a carriage 174. In some embodiments, the carriage 174 is supported by a rail system (not shown) that allows linear motion.

When the ball screw 172 is rotated, the ball screw 172 is rotated within the threaded aperture 171, causing the carriage 174 to move in a substantially linear manner. The movable plate 164 can be coupled to the carriage 174, and accordingly, can move relative to a base 180 of the Z printhead positioning assembly 116 when the carriage 174 is moved. The base 180 of the Z printhead positioning assembly 116 can be coupled to the substantially vertically-oriented face 128 of the support 102 shown in FIG. 7, although other manners of mounting the Z printhead positioning assembly 116 are possible. Accordingly, when the carriage 174 and the movable plate 164 are moved, the mounting plate 120 illustrated in FIGS. 6 and 8 (and the components of the arrayer 100 coupled to the mounting plate 120) are also moved relative to the base 180 and the support 102. This arrangement of elements can allow rapid positioning of the printhead 108 and imaging system 118 relative to a substrate 114 positioned on or coupled to the stage 112.

The Z printhead positioning assembly 116 shown in FIGS. 6, 8 and 13 can further include one or more covers, such as a first cover 182 and a second cover 184. In the illustrated embodiment, the first cover 182 fits over the actuator 170 and is coupled to the base 180 when in an assembled position. The first cover 182 therefore covers and protects the actuator 170, as well as other portions of the Z printhead positioning assembly 116. The second cover 184 fits over at least a portion of the carriage 174 and is coupled to the base 180. The second cover 184 therefore covers and protects the carriage 174, the ball screw 172, and other portions of the Z printhead positioning assembly 116.

As mentioned above, the stage 112 can be coupled to and movable by the X-Y-Z stage-positioning assembly 110. One embodiment of the X-Y-Z stage-positioning assembly 110 is shown in FIGS. 14-21. With reference first to FIG. 14, the X-Y-Z stage-positioning assembly 110 can include an X portion 200 which can move the stage 112 in an X direction in an X-Y plane, a Y portion 202 which can move the stage 112 in a Y direction orthogonal to the X direction in the X-Y plane, and a Z portion 204 which can move at least a portion of the stage 112 toward and away from the X-Y plane in a Z direction, wherein the Z direction is orthogonal to both the X direction and the Y direction. In the embodiment illustrated in FIGS. 14-21, each of the X portion 200, the Y portion 202, and the Z portion 204 is a separate component. However, in some embodiments of the present invention, two or more of the X portion 200, the Y portion 202 and the Z portion 204 are formed of the same part, or are integrally formed.

In the embodiment shown in FIG. 14, the X portion 200 is illustrated as being at the bottom of the X-Y-Z stage-positioning assembly 110, the Y portion 202 is illustrated as being stacked on top of the X portion 200 in the middle of the X-Y-Z stage-positioning assembly 110, and the Z portion 204 is illustrated as being stacked on top of the Y portion 202 at the top of the X-Y-Z stage-positioning assembly 110. Accordingly, in the illustrated embodiment, the X portion 200 can be coupled to the base 124 of the support 102 (or other underlying structure, as desired), and the Z portion 204 can be coupled to the stage 112. However, it should be understood that any arrangement of the X portion 200, the Y portion 202 and the Z portion 204 that allows movement of the stage 112 in the X, Y and Z directions with the same level of precision and repeatability is within the spirit and scope of the present invention. In this regard, it should also be noted that the X, Y, and Z portions 200, 202, 204 need not necessarily be positioned such that one overlies another. In some alternative embodiments, one or more of the X, Y, and Z portions 200, 202, 204 are laterally displaced with respect to the other portions (although still being coupled thereto in order to provide the desired movement of the stage 112).

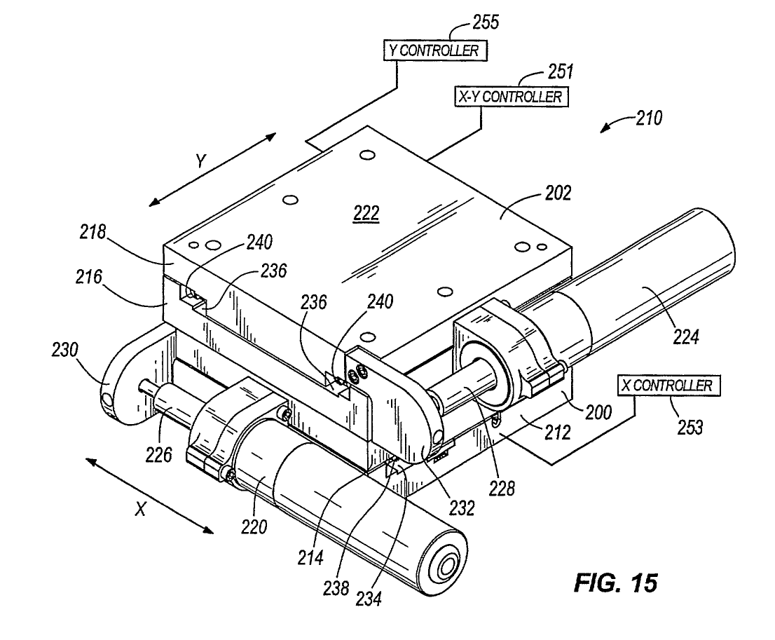

The X portion 200 and the Y portion 202 can make up an X-Y stage-positioning assembly 210. In some embodiments, the stage 112 is not movable in the Z direction, but is instead coupled to the X-Y stage-positioning assembly 210 for movement in an X-Y plane. The X-Y stage-positioning assembly 210 is shown in greater detail in FIGS. 15-18.

As shown in FIGS. 15-18, the X portion 200 is identical to the Y portion 202 in the illustrated embodiment, except that the X portion 200 is oriented to move in an X direction as shown in FIGS. 15-18, and the Y portion 202 is oriented to move in a Y direction substantially perpendicular to the X direction, as also shown in FIGS. 15-18. The X portion 200 can include a first platform 212 and a second platform 214. Similarly, the Y portion 202 can include a first platform 216 and a second platform 218. Each of the first platforms 212, 216 can be fixed relative to a surface to which the X portion 200 or the Y portion 202 is coupled, while each of the second platforms 214, 218 can be movable relative to the first platforms 212, 216, respectively.

In some embodiments, the first platform 212 of the X portion 200 is coupled to the base 124 of the support 102 (or other underlying structure), thereby forming a stationary base for the X-Y stage-positioning assembly 210 (and the X-Y-Z stage-positioning assembly 110). Also, in some embodiments the first platform 216 of the Y portion 202 is coupled to the second platform 214 of the X portion 200. Thus, the first platform 216 of the Y portion 202 (and any elements coupled to the first platform 216) can be movable with the second platform 214 of the X portion 200 in an X direction relative to the first platform 212 of the X portion 200 and the base 124 of the support 102 or other underlying structure. Furthermore, the second platform 218 of the Y portion 202 (and any elements coupled to the second platform 218) can be movable in a Y direction relative to the first platform 216 of the Y portion 202. The second platform 218 can include an upper surface 222 to which various elements can be coupled (e.g., the Z portion 204, the stage 112, and any elements coupled thereto).

Because motion in the X direction is controlled by the X portion 200 and motion in the Y direction is controlled by the Y portion 202, the X-Y stage-positioning assembly 210 allows for movement in the X direction independent of movement in the Y direction. That is, a substrate 114 positioned on the stage 112 can be independently moved in the X direction and the Y direction, and the substrate 114 can be moved in the X direction simultaneously to being moved in the Y direction.

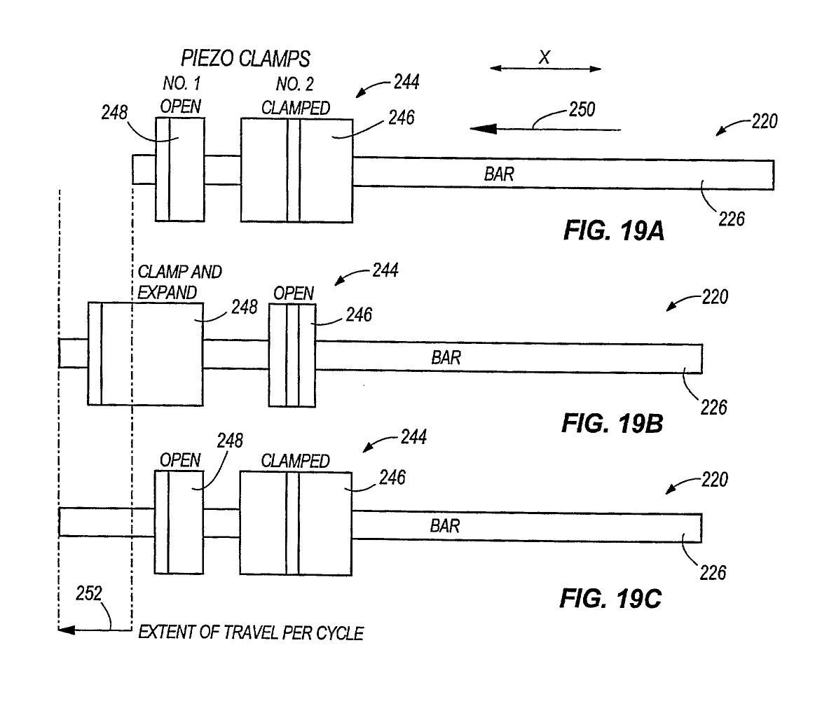

Each of the second platforms 214, 218 can be moved by an actuator 220, 224, respectively. The actuators 220, 224 can be the same or different from one another, and can take a number of different forms capable of moving and positioning the second platforms 214, 218 in a precise and repeatable manner. In some embodiments, either or both actuators 220, 224 are capable of such motion to achieve a spatial resolution of less than approximately 20 nm, and less than approximately 1 nm in some embodiments. In some embodiments, either or both actuators 220, 224 are capable of a reproducible spatial resolution of less than about 1 micron, and in some embodiments less than about 500 nm. In some embodiments, either or both actuators 220, 224 are capable of speeds of up to about 5 mm/second, and in some embodiments, up to about 7 mm/second. For example, in the illustrated embodiment, the actuators 220, 224 each include a piezo inchworm actuator, the mechanism of which is shown in FIGS. 19A-19C and described below. As other examples, any of the other actuator types disclosed herein can instead be used.

In other embodiments, either or both of the platforms 214, 216 can be moved by other types of actuators capable of the above-described precision, including a number of different electromotive actuators currently available. For example, either or both platforms 214, 216 can be moved by any other type of piezoelectric actuator. As used herein and in the appended claims, the term “piezo actuator” or “piezoelectric actuator” is used to refer to any piezoelectric-driven mechanism or actuator, including, but not limited to, piezo inchworm actuators, piezo flexure stages or nanopositioners, piezo ratchet devices, piezo devices, piezo ceramic devices, piezo bimorph stacks, piezoelectric linear or rotary stick-slip actuators, piezoelectric stack actuators, piezoelectric shear actuators, piezoelectric tube actuators, and the like, and/or any other suitable piezoelectric-driven actuator or mechanism.

In some embodiments, either or both platforms 214, 216 are driven by actuators or mechanisms other than piezoelectric actuators. As an example, either or both platforms 214, 216 can be coupled to and driven by electrostrictive actuators, such as electrostrictive stack actuators, electrostrictive ring actuators, electrostrictive elastomers, and the like. As another example, either or both platforms 214, 216 can be coupled to and driven by magnetostrictive actuators, such as coil and rod magnetostrictive actuators. As yet another example, either or both platforms 214, 216 can be coupled to and driven by a micro-electro-mechanical system (MEMS) actuator, such as residual stress cantilevered (RSC) MEMS actuators, vertical thermal MEMS actuators (VTA), scratch drive MEMS actuators (SDA), horizontal thermal MEMS actuators (HTA), and the like.

With reference again to FIGS. 15-18, each piezo actuator 220, 224 in the illustrated embodiment can drive a bar 226, 228, respectively. Each bar 226, 228 can be coupled to a follower 230, 232, respectively, and each follower 230, 232 can be coupled to a respective second platform 214, 218 of the X and Y portions 200, 202. The followers 230, 232 and platforms 212, 214, 216, 218 can have any shape in which this relationship between the followers 230, 232 and platforms 212, 214, 216, 218 is possible. In the illustrated embodiment, each first platform 212, 216 includes recesses 234, 236, respectively, and each second platform 214, 218 includes protrusions 238, 240 which fit adjacent and move along the respective recesses 234, 236 as the second platform 214 or 218 is moved relative to the first platform 212 or 216. Also in the illustrated embodiment, each of the X portion 200 and the Y portion 202 includes two recesses 234, 236 and two corresponding protrusions 238, 240, wherein each recess 234, 236 and each protrusion 238, 240 is stepped to minimize wobble and enhance stability. In other embodiments, any number of recesses 234, 236 and protrusions 238, 240 (if employed) having any shape can be used to accomplish the same or similar functions. The specific structures for the bars 226, 228, followers 230, 232, recesses 234, 236 and protrusions 238, 240 are shown in FIGS. 15-18 by way of example only, it being understood that the precise and repeatable movement of the X portion 200 and the Y portion 202 can be accomplished using a variety of other structures.

FIGS. 19A-19C show portions of the actuator 220 of the X portion 200 from the illustrated embodiment. The actuator 224 of the Y portion 202 and its associated elements can function in a similar manner. The actuator 220 can function by using two or more clamping elements 244 capable of holding the bar 226 and moving the bar 226 along the X direction by expanding and/or contracting. By reiteration of this process, the bar 226 can be moved in the X direction a considerable distance with extremely high precision. The direction of motion in FIGS. 19A-19C is shown by arrow 250. In some embodiments, the clamping elements 244 are formed of a piezoelectric material that has precise motion and reproducibility parameters. Thus, by a series of clamp, move, and release actions, the bar 226 can be moved. In some embodiments, the bar 226 can be moved rapidly relative to the resolution achieved, such as in the range of millimeters per second.

The clamping elements 244 of the embodiment illustrated in FIGS. 19A-19C can be generally cylindrical in shape and can clamp around the circumference of the bar 226 by decreasing an inner diameter (“closing”) to fit around the circumference of the bar 226. In operation of the illustrated embodiment, a first clamping element 246 is closed around the bar 226 as shown in FIG. 19A, while a second clamping element 248 is open. As shown in FIG. 19B, the first clamping element 246 then opens, and the second clamping element 248 closes around the bar 226. The second clamping element 248 is then directed to expand and grow in length, as shown in FIG. 19B. As the second clamping element 248 expands, it causes the bar 226 to move in the direction of arrow 250, because the first clamping element 246 remains open. After the second clamping element 248 has moved the bar 226 a distance 252 as shown in FIG. 19C, the first clamping element 246 closes around the bar 226, and the second clamping element 248 is opened and allowed to contract back to its original state and position as shown in FIG. 19C to allow the cycle to be repeated. The cycle can be repeated indefinitely, and is usually limited only by the straightness of the bar 226. This piezo inchworm mechanism can provide nanometer-scale precision and reproducibility of movement. With each cycle, the bar 226 can be moved a distance 252. By incorporating encoders (e.g., optical encoders, laser interferometers, or any other suitable encoder) in the motion control mechanism of the X portion 200, the degree of movement can be tracked very accurately, and the bar 226 can be returned to its original coordinates with nanometer-scale resolution.

Movement of the X-Y stage-positioning assembly 210 can be controlled by the controller 122, or the X-Y stage-positioning assembly 210 can be controlled by one or more local controllers, as shown in FIG. 15. For example, in some embodiments, the X-Y stage-positioning assembly 110 can be controlled by an X-Y controller 251. In some embodiments, the X portion 200 can be independently controlled by an X controller 253, and in some embodiments, the Y portion 202 can be independently controlled by a Y controller 255.

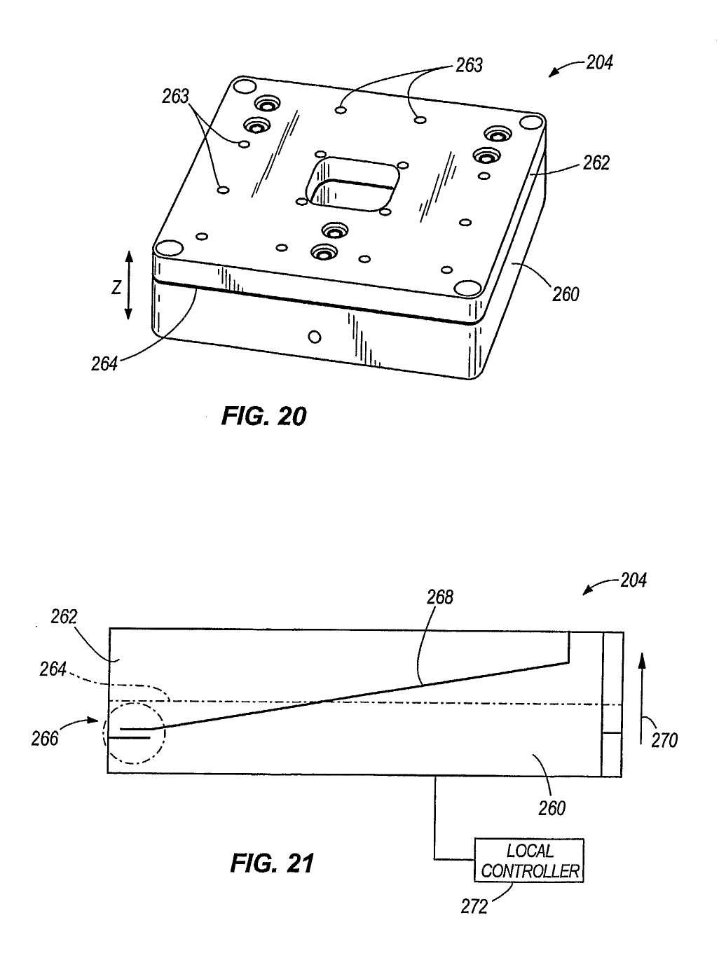

FIG. 20 illustrates an embodiment of the Z portion 204 of the X-Y-Z stage-positioning assembly 110 illustrated in FIG. 14. The Z portion 204 is also sometimes referred to herein as the Z stage-positioning assembly 204, because the Z portion 204 is coupled to the X-Y stage-positioning assembly 210 to form the X-Y-Z stage-positioning assembly 110. As shown in FIG. 20, in some embodiments, the Z portion 204 includes a base 260 and a platform 262 movable upwardly and downward in a Z direction relative to the base 260. The base 260 and the platform 262 can be separated by a gap 264, which can grow or shrink in the Z direction when the platform 262 is moved in the Z direction relative to the base 260. As shown in FIG. 14, the base 260 of the Z portion 204 can be coupled to the X-Y stage-positioning assembly 210, and, specifically, to the second platform 218 of the Y portion 202. The stage 112 can be coupled to the platform 262 and movable therewith. The Z portion 204 shown in FIG. 20 includes a plurality of mounting apertures 263, although it will be appreciated that the Z portion 204 can be coupled to the stage 112 in a variety of different manners without departing from the spirit and scope of the present invention, including those described above with reference to the connection between the X-Y-Z stage-positioning assembly 110 and the base 124.

In some embodiments, the platform 262 can be movable in the Z direction in a precise and repeatable fashion to allow the stage 112, and any substrate 114 positioned or otherwise supported on the stage 112, to be moved in a spatial resolution of less than approximately 20 nm, in some embodiments, less than 10 nm in some embodiments, and about 1 nm, in some embodiments. In some embodiments, the platform 262 is movable with respect to the base 260 by a total distance of less than approximately 200 microns, in some embodiments less than approximately 100 microns, and in some embodiments, less than approximately 50 microns. In some embodiments, the platform 262 has a full range repeatability of about +/−100 nm or less, in some embodiment about +/−50 nm or less, and in some embodiments, about +/−20 nm or less. In some embodiments, a Z portion 204 that can achieve this total range of motion, spatial resolution and repeatability is a piezo flexure nanopositioner (e.g., a Vertical PZT Flexure Stage, available from PI, product no. P-762.TL). However, a number of other electromotive actuators can instead be employed to provide the same or comparable spatial resolution and range of motion, including those described above with reference to the actuators for the X and Y portions 200, 202.

FIG. 21 shows a schematic illustration of the Z portion 204 of FIG. 20, and one embodiment of a mechanism of motion control that can be used in the Z portion 204 (namely, a piezo flexure mechanism). In some embodiments, the flexure mechanism includes a hinge 266 and a lever 268. In some embodiments, the hinge 266 is a living hinge which can be formed into a part (such as by machining or molding a metal or polymer part). The hinge 266 and the lever 268 allow the platform 262 to move relative to the base 260.

In some embodiments, movement of the platform 262 can be accomplished using a piezo ceramic device (e.g., a piezo bimorph stack) that applies a force at a particular position of the platform 262. The piezo ceramic device can be mounted within the Z portion 204 in a variety of locations to obtain the desired degree of motion as a function of piezo expansion. The hinge 266 can be formed of a material and dimensioned to allow repeated flexing with minimal material degradation. A plurality of hinges 266 and levers 268 can be used in the Z portion 204 and can be positioned throughout the Z portion 204 to move the platform 262 in the Z direction (see arrow 270 in FIG. 21).

The Z portion 204, and specifically, the motion of the platform 262 can be controlled by the controller 122. In some embodiments, however, the Z portion 204 is controlled by a local controller 272 in addition to, or in lieu of, the controller 122. In some embodiments, the local controller 272 can include a linear variable differential transformer (LVDT) or other position monitoring devices, which can include a displacement feedback circuit to monitor and control movement of the platform 262. In this regard, LVDTs or other position monitoring devices can be coupled to the X portion 200, Y portion 202, and/or the Z printhead-positioning assembly 116 for monitoring and controlling movement of such arrayer devices.

In some embodiments, the Z printhead positioning assembly 116 is responsible for moving the printhead 108 (and, accordingly, the SPT 146) by moving the mounting plate 120 and the movable plate 164 of the Z printhead positioning assembly 116 into relatively close proximity to a substrate 114 on or otherwise supported by the stage 112. The Z printhead positioning assembly 116 in such embodiments can be generally responsible for coarse movement of the printhead 108, and can include a larger spatial resolution than that achieved by the X-Y-Z stage-positioning assembly 110. The controller 122 can be used to move and control the position of the Z printhead positioning assembly 116. After the printhead 108 has been positioned in close proximity with a substrate 114 onto which material is to be deposited (and/or loaded from, in some embodiments), the controller 122 can be used to control the X-Y-Z stage-positioning assembly 110 to move the stage 112, and accordingly, the substrate 114, in an X direction, a Y direction and a Z direction to load materials from the substrate 114 and/or to deposit materials from the SPT 146 onto the substrate 114.

In some embodiments, the X-Y-Z stage positioning assembly 110 is repeatedly moved to deposit one or more arrays of spots upon the substrate 114. The array(s) created by this process can include at least 2 spots and as many as several thousand (or more) spots in a variety of patterns or shapes deposited at a resolution as small as about 20 nm and each having a spot size of about 250 nm to about 25 microns in some embodiments (although smaller or larger spot sizes are possible).

Also, in some embodiments, the SPT 146 can deposit material in the form of lines. In such embodiments, the lines can have thicknesses of about 250 nm to about 50 microns in some embodiments, (although thinner or thicker lines are possible). Spots, lines, and combinations thereof can be used to create various designs or patterns on the substrate 114.

In the illustrated embodiment of FIGS. 6-9A and 13-21, the X-Y-Z stage positioning assembly 110 is adapted to position the stage 112 (and a substrate thereon or otherwise supported thereby) in X and Y directions with a relatively high resolution enabled by the use of piezo actuators 220, 224 coupled to the X and Y portions 200, 202 of the X-Y-Z stage positioning assembly 110. Also in the illustrated embodiment of FIGS. 6-9A and 13-21, the X-Y-Z stage positioning assembly 110 is adapted to position the stage 112 in a Z direction with relatively high resolution enabled by the use of a piezo flexure stage of the Z portion 204. In this embodiment, the actuator of the Z printhead positioning assembly 116 used to move and position the mounting plate 120 (and the SPT 146 and other arrayer components coupled thereto) can have a lower resolution positioning capability. The selection of actuator types for the Z printhead positioning assembly 116 and the X-Y-Z stage positioning assembly 110 can be based at least in part upon the desired precision of movement and the desired maximum speed of such arrayer components.

With reference to FIGS. 6-9A and 13-21 for example, a faster and less precise (and in some cases, less expensive) actuator can be used to drive the Z printhead positioning assembly 116, while a slower and more precise (and in some cases, more expensive) actuator can be used to drive the X, Y, and/or Z portions 200, 202, 204 of the X-Y-Z stage positioning assembly 110. In this manner, the relative position between the SPT 146 and the stage 112 can be changed significantly and relatively quickly by the actuator of the Z printhead positioning assembly 116, while more precise relative movement between the SPT 146 and the stage 112 can be accomplished by the actuators of the X-Y-Z stage positioning assembly 110. Accordingly, the SPT 146 can be coupled to (e.g., via the printhead 108) and moved by an actuator that is faster than the actuators coupled to and driving the X-Y-Z stage positioning assembly 110, thereby providing a type of coarse adjustment for the arrayer 100. Similarly, the X-Y-Z stage positioning assembly 110 can be coupled to and moved by one or more actuators that are more precise (although possibly slower) than the actuator coupled to and driving the SPT 146, thereby providing a type of fine adjustment for the arrayer 100.

However, in other embodiments, such coarse and fine adjustment is possible through the use of different actuator types used to move and position the stage 112 and the SPT 146. For example, the SPT 146 can also or instead be coupled to and driven in the Z direction by any of the electromotive actuators described above with reference to the X and Y portions 200, 202 in the illustrated embodiment of FIGS. 6-9A and 13-21, thereby providing the Z printhead positioning assembly 116 with higher positioning resolution. As another example, either or both of the X and Y portions 200, 202 in the illustrated embodiment of FIGS. 6-9A and 13-21 can also be coupled to and driven in the X and Y directions, respectively, by a ball screw linear actuator, a servo motor, a stepper motor, or other actuator coupled to and controlled by a respective controller or the controller 122. In this manner, the X and Y portions 200, 202 can be moved more quickly into and out of desired positions with respect to the SPT 146, while still being movable with higher resolution by their respective piezo actuators 220, 224.

Any of the actuators employed to move the X, Y, and Z portions 100, 102, 104 of the X-Y-Z stage positioning assembly 110 and the SPT 146 can be replaced or supplemented with an actuator having relatively less precision (e.g., a ball screw linear actuator, a servo motor, a stepper motor) or with an actuator having a relatively higher precision (e.g., those electromotive actuators described above with reference to the X and Y portions 200, 202 in the illustrated embodiment of FIGS. 6-9A and 13-21). However, it is desirable that the SPT 146 and/or the X-Y-Z stage positioning assembly 110 be coupled to and driven by at least one actuator with relatively high precision as just described for relative movement between the SPT 146 and/or the X-Y-Z stage positioning assembly 110 in each of the X, Y, and Z directions. It is also desirable that the SPT 146 and/or the X-Y-Z stage positioning assembly 110 have at least one actuator capable of faster motion (e.g., a ball screw linear actuator, a servo motor, a stepper motor, and the like) for relatively faster movement between the SPT 146 and the X-Y-Z stage positioning assembly 110 in at least one of the X, Y, and Z directions.

Although the SPT 146 illustrated in the embodiment of FIGS. 6-9A and 13-21 is coupled for movement in the Z-direction, while the stage 112 is coupled for movement in the X, Y, and Z directions, in other embodiments the SPT 146 can be coupled for movement in the X and/or Y directions, and the stage 112 can be coupled for movement in fewer than all of the X, Y, and Z directions. In this regard, either the SPT 146 or the stage 112 can be stationary (e.g., incapable of motion in the Z direction), in which case the other of these two arrayer components can be coupled for movement by any of the relatively high-precision electromotive actuators described above with reference to the X and Y portions 200, 202 in the illustrated embodiment of FIGS. 6-9A and 13-21. In other embodiments, both the SPT 146 and the stage 112 can be coupled to and driven by such high-precision electromotive actuators.

Also, in some embodiments, the SPT 146 is movable in the X direction by an actuator of any type described herein. In some embodiments, such an actuator can have relatively high precision, such as those described above with reference to the X and Y portions 200, 202 in the illustrated embodiment of FIGS. 6-9A and 13-21. In such cases, the X portion 200 of the X-Y-Z stage positioning assembly 110 can be stationary, if desired, or need not necessarily be employed at all.

Similarly, in some embodiments, the SPT 146 is also or instead movable in the Y direction by an actuator of any type described herein. In some embodiments, such an actuator can have relatively high precision, such as those described above with reference to the X and Y portions 200, 202 in the illustrated embodiment of FIGS. 6-9A and 13-21. In such cases, the Y portion 202 of the X-Y-Z stage positioning assembly 110 can be stationary, if desired, or need not necessarily be employed at all.

With reference to the various arrayer embodiments described and illustrated herein, any one or more of the actuators in such embodiments can be controlled independently of the others. In some embodiments, each of actuators is controllable independently of the other actuators, thereby providing a significant degree of control over relative motion of the SPT 146 and stage 112.

The information and examples described herein are for illustrative purposes and are not meant to exclude any derivations or alternative methods that are within the conceptual context of the invention. It is contemplated that various deviations can be made to this embodiment without deviating from the scope of the present invention. Accordingly, it is intended that the scope of the present invention be dictated by the appended claims rather than by the foregoing description of this embodiment. Various features and aspects of the invention are set forth in the following claims.

What is claimed is:

1. A system for depositing a material onto a substrate to create a desired surface pattern, the system comprising:
a support;
a surface patterning tool coupled to the support, the surface patterning tool adapted to deposit the material onto the substrate;
a controller; and
first, second, and third actuators electrically coupled to and controlled by the controller,
wherein the first, second, and third actuators are operable to move the substrate in X, Y, and Z directions, respectively, with respect to the surface patterning tool, wherein the substrate is movable by the first, second, and third actuators to different positions with respect to the surface patterning tool, and wherein material is transferable from the surface patterning tool to the substrate in each of the different positions to define the desired surface pattern.

2. The system as claimed in claim 1, wherein at least one of the first, second, and third actuators is a piezoelectric actuator.

3. The system as claimed in claim 1, wherein the first and second actuators are piezoelectric actuators.

4. The system as claimed in claim 1, further comprising a fourth actuator coupled to the controller and to the surface patterning tool, the fourth actuator operable to move the surface patterning tool with respect to the substrate.

5. The system as claimed in claim 4, wherein the fourth actuator is operable to move the surface patterning tool in the Z direction with respect to the substrate.

6. The system as claimed in claim 5, wherein the fourth actuator is operable independently of the first, second, and third actuators.

7. The system as claimed in claim 1, wherein the first, second, and third actuators are operable independently with respect to one another.

8. The system as claimed in claim 1, further comprising a platform coupled to the first actuator, wherein the platform is movable by the first actuator with respect to the surface patterning tool.

9. The system as claimed in claim 8 further comprising a second platform coupled to the second actuator, wherein the second platform is movable by the second actuator with respect to the first platform.

10. A system for depositing a material onto a substrate to create a desired surface pattern, the system comprising:
a support;
a surface patterning tool coupled to the support, the surface patterning tool adapted to deposit the material onto the substrate;
a controller; and
first and second piezoelectric drives electrically coupled to and controlled by the controller,
wherein the first and second piezoelectric actuators are operable to move the substrate in X and Y directions, respectively, with respect to the surface patterning tool, wherein the substrate is movable by the first and second piezoelectric actuators to different positions with respect to the surface patterning tool, and wherein material is transferable from the surface patterning tool to the substrate in each of the different positions to define the desired surface pattern.

11. The system as claimed in claim 10, further comprising a third piezoelectric actuator operable to move the substrate in a Z direction with respect to the surface patterning tool.

12. The system as claimed in claim 10, further comprising a third actuator coupled to the controller and to the surface patterning tool, the third actuator operable to move the surface patterning tool with respect to the substrate.

13. The system as claimed in claim 12, wherein the third actuator is operable to move the surface patterning tool in the Z direction with respect to the substrate.

14. The system as claimed in claim 13, wherein the third actuator is operable independently of the first and second actuators.

15. The system as claimed in claim 10, wherein the first and second actuators are operable independently with respect to one another.

16. The system as claimed in claim 10, further comprising a platform coupled to the first actuator, wherein the platform is movable by the first actuator with respect to the surface patterning tool.

17. The system as claimed in claim 16 further comprising a second platform coupled to the second actuator, wherein the second platform is movable by the second actuator with respect to the first platform.

18. A method of depositing a material onto a substrate to create a desired surface pattern, the method comprising:
loading the material onto a surface patterning tool;
actuating a first actuator to move the substrate in an X direction with respect to the surface patterning tool;
actuating a second actuator to move the substrate in a Y direction with respect to the surface patterning tool;
actuating a third actuator to move the substrate in a Z direction with respect to the surface patterning tool and to a position with respect to the surface patterning tool; and
transferring the material from the surface patterning tool to the substrate.

19. The method as claimed in claim 18, wherein at least one of the first and second actuators is a piezoelectric actuator.

20. The method as claimed in claim 18, further comprising:
moving a first platform and a second platform via the first actuator;
moving the second platform via the second actuator to move the second platform with respect to the first platform and the surface patterning tool.
